(19) United States
(12) Patent Application Publication
(10) Pub. No.: US 2026/0352541 A1
(43) Pub. Date: Nov. 5, 2026

(54) TRAFFIC ANOMALY DETECTION AT NETWORK EDGE

(71) Applicant: Juniper Networks, Inc., Sunnyvale, CA (US)

(72) Inventors: Mohammad Zohoorian, San Francisco, CA (US); Xiaoying Wu, Sunnyvale, CA (US); Nicolas S. Dade, Santa Cruz, CA (US); Satish Jain, San Jose, CA (US); Keh-Ming Luoh, Fremont, CA (US)

(21) Appl. No.: 19/664,789

(22) Filed: Apr. 30, 2026

Related U.S. Application Data
(60) Provisional application No. 63/798,375, filed on May 1, 2025.
(60) Provisional application No. 63/980,629, filed on Feb. 11, 2026.

(51) Int. Cl. H04L 41/0631; H04L 41/142; H04L 41/147; H04L 67/10

(52) U.S. Cl. CPC H04L 41/0631; H04L 41/142; H04L 41/147; H04L 67/10

(57) ABSTRACT

Techniques are described for anomaly detection and root cause analysis based on usage statistics for a plurality of network access server (NAS) devices across two or more sites of a network obtained from a network edge device. The edge device provides a centralized data plane for the NAS devices with access to a cloud-based control plane provided by a network management system (NMS). The NMS predicts usage statistics at the edge device for a time window based on a pattern identified in the usage statistics for the plurality of NAS devices. The NMS detects an anomaly in the usage statistics for the time window based on a difference between actual usage statistics observed at the edge device for the time window and the predicted usage statistics for the time window. The NMS then determines a root cause of the detected anomaly based on a type of the detected anomaly.

This application claims the benefit of U.S. Provisional Patent Application No. 63/798,375, filed May 1, 2025, and U.S. Provisional Patent Application No. 63/980,629, filed Feb. 11, 2026, the entire content of each application is incorporated herein by reference.

### BACKGROUND

Organizations may include a plurality of commercial premises or sites that are interconnected within a network. Each premises or site may install complex wireless network systems, including a network of network access server (NAS) devices, such as wireless access points (APs), throughout the premises to provide wireless network services to one or more wireless client devices (or simply, “clients”). APs are physical, electronic devices that enable other devices to wirelessly connect to a wired network using various wireless networking protocols and technologies. Many different types of wireless client devices incorporate wireless communication technology and can be configured to connect to wireless access points when the device is in range of a compatible wireless access point in order to access a wired network. In the case of a client device running a cloud-based application, data is exchanged during an application session from the client device through one or more APs and one or more wired network devices, e.g., switches, routers, and/or gateway devices, to reach the cloud-based application server.

### BRIEF DESCRIPTION OF DRAWINGS

FIG. 1A is a block diagram of an example network system including a network management system and at least one network edge device, in accordance with one or more techniques of the disclosure.

FIG. 1B is a block diagram illustrating further example details of the network system of FIG. 1A.

FIG. 2 is a block diagram of an example network edge device, in accordance with one or more techniques of this disclosure.

FIG. 3A is a block diagram of an example network management system, in accordance with one or more techniques of the disclosure.

FIG. 3B is a conceptual diagram of an example anomaly detection unit of the network management system of FIG. 3A.

FIG. 3C is a block diagram of an example root cause analysis unit of the network management system of FIG. 3A.

FIG. 4 is a flow chart illustrating an example operation of traffic anomaly detection at a network edge, in accordance with one or more techniques of this disclosure.

### DETAILED DESCRIPTION

In general, this disclosure describes one or more techniques for traffic anomaly detection and root cause analysis based on network data obtained from a network edge device. The network edge device provides a centralized data plane for a plurality of network access server (NAS) devices across two or more sites of a network with access to a cloud-based control plane provided by a network management system (NMS). For example, the edge device may operate to extend certain microservices from the NMS to the on-premises NAS devices while using the NMS and its distributed software architecture for scalable and resilient operations, management, troubleshooting, and analytics.

According to the disclosed techniques, the NMS obtains the network data for the NAS devices from the network edge device. The network data includes usage statistics for the NAS devices, including aggregate usage statistics and/or average usage statistics for the plurality of NAS devices across the two or more sites. The NMS predicts usage statistics at the network edge device for a time window in accordance with a pattern or seasonality identified in the usage statistics for the plurality of NAS devices. The NMS detects an anomaly in the usage statistics for the time window based on a difference between actual usage statistics observed at the network edge device for the time window and the predicted usage statistics for the time window. The NMS then determines a root cause of the detected anomaly based on a type of the detected anomaly.

The disclosed techniques may provide one or more advantages and/or practical applications. Because the edge device may be used across two or more sites and reports aggregated and/or average data for the plurality of NAS devices within the two or more sites, different analysis techniques may need to be applied to and/or different insights may be determined from the aggregated and/or average data than network data or usage statistics obtained directly from each of the NAS devices at each of the sites. Namely, the aggregated and/or average data obtained from the edge device provides customer enterprise- or organization-level insights that may not be determined from device-level data. For example, the usage statistics may comprise aggregate traffic statistics for the plurality of NAS devices across the two or more sites, an average number of tunnels established between the plurality of NAS devices across the two or more sites and a tunnel terminator at the network edge device, and an aggregate client count of wired and/or wireless clients across the two or more sites connected to the network edge device. The average number of tunnels is indicative of a number of NAS devices connected to the edge device at a customer organization-level, and the disclosed techniques may detect an anomaly and corresponding root cause based on aggregate packet drops, aggregate traffic errors, and/or aggregate traffic spikes in the traffic carried via the tunnels, a drop or spike in the average number of tunnels themselves, and/or a drop or spike in the aggregate client count.

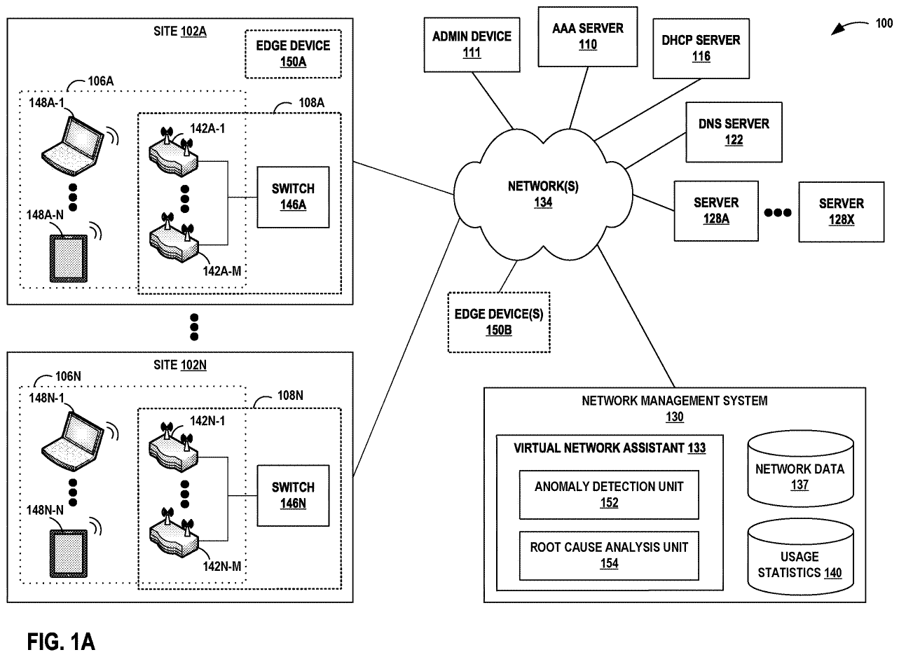

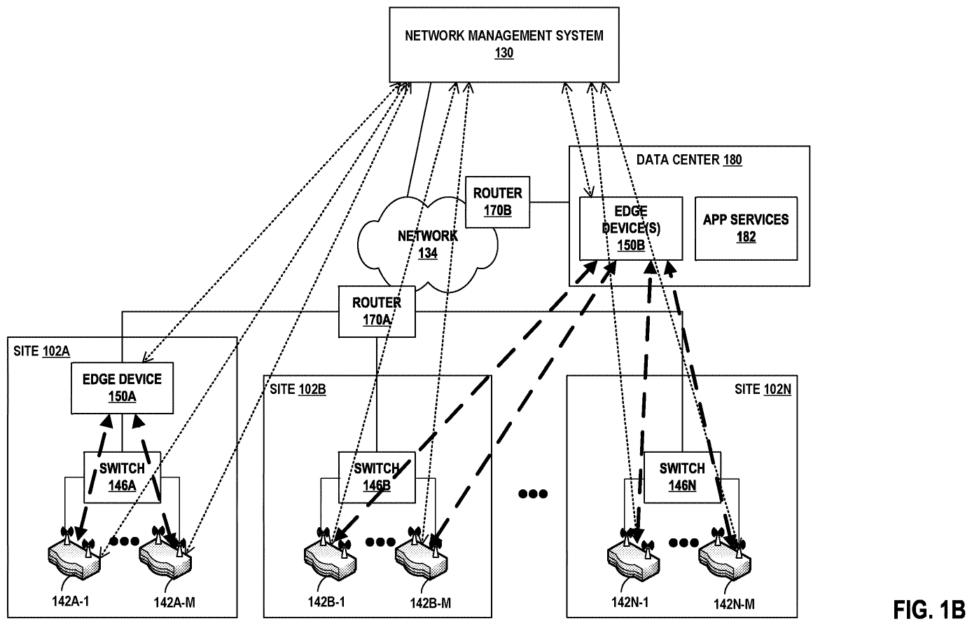

FIG. 1A is a block diagram of an example network system 100 including network management system (NMS) 130 and at least one network edge device 150A, 150B, in accordance with one or more techniques of this disclosure. Example network system 100 includes a plurality sites 102A-102N at which a network service provider manages one or more wireless networks 106A-106N, respectively. Although in FIG. 1A each site 102A-102N is shown as including a single wireless network 106A-106N, respectively, in some examples, each site 102A-102N may include multiple wireless local area networks (WLANs), and the disclosure is not limited in this respect.

Each site 102A-102N includes a plurality of network access server (NAS) devices, such as access points (APs) 142, switches 146, or routers (not shown). For example, site 102A includes a plurality of APs 142A-1 through 142A-M. Similarly, site 102N includes a plurality of APs 142N-1 through 142N-M. Each AP 142 may be any type of wireless access point, including, but not limited to, a commercial or enterprise AP, a router, or any other device that is connected to a wired network and is capable of providing wireless network access to client devices within the site.

Each site 102A-102N also includes a plurality of client devices 148, otherwise known as user equipment devices (UEs), representing various wireless-enabled devices within each site. For example, a plurality of client devices 148A-1 through 148A-N are currently located at site 102A. Similarly, a plurality of client devices 148N-1 through 148N-N are currently located at site 102N. Each of client devices 148 may be any type of wireless client device, including, but not limited to, a mobile device such as a smart phone, tablet or laptop computer, a personal digital assistant (PDA), a wireless terminal, a smart watch, smart ring, or other wearable device. Client devices 148 may also include wired client-side devices, e.g., IoT devices such as printers, security devices, environmental sensors, or any other device connected to the wired network and configured to communicate over one or more wireless networks 106.

In order to provide wireless network services to client devices 148 and/or communicate over the wireless networks 106, APs 142 and the other wired client-side devices at sites 102 are connected, either directly or indirectly, to one or more network devices (e.g., switches, routers, or the like) via physical cables, e.g., Ethernet cables. In the example of FIG. 1A, site 102A includes a switch 146A to which each of APs 142A-1 through 142A-M at site 102A are connected. Similarly, site 102N includes a switch 146N to which each of APs 142N-1 through 142N-M at site 102N are connected. Although illustrated in FIG. 1A as if each site 102 includes a single switch 146 and all APs 142 of the given site 102 are connected to the single switch 146, in other examples, each site 102 may include more or fewer switches and/or routers. In addition, the APs and the other wired client-side devices of the given site may be connected to two or more switches and/or routers. In addition, two or more switches at a site may be connected to each other and/or connected to two or more routers, e.g., via a mesh or partial mesh topology in a hub-and-spoke architecture. In some examples, interconnected switches and routers comprise wired local area networks (LANs) at sites 102 hosting wireless networks 106.

Example network system 100 also includes various networking components for providing networking services within the wired network including, as examples, an Authentication, Authorization and Accounting (AAA) server 110 for authenticating users and/or client devices 148, a Dynamic Host Configuration Protocol (DHCP) server 116 for dynamically assigning network addresses (e.g., IP addresses) to client devices 148 upon authentication, a Domain Name System (DNS) server 122 for resolving domain names into network addresses, a plurality of servers 128A-128X (collectively “servers 128”) (e.g., web servers, databases servers, file servers and the like), and NMS 130. As shown in FIG. 1A, the various devices and systems of network 100 are coupled together via one or more network(s) 134, e.g., the Internet and/or an enterprise network.

In the example of FIG. 1A, NMS 130 is a cloud-based computing platform that manages wireless networks 106A-106N at one or more of sites 102A-102N. As further described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. In some examples, NMS 130 outputs notifications, such as alerts, alarms, graphical indicators on dashboards, log messages, text/SMS messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

The administrator and admin device 111 may comprise IT personnel and an administrator computing device associated with one or more of sites 102. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of the NAS devices, e.g., APs 142, switches 146, or routers, may optionally connect to network edge devices 150A-150B (collectively, “edge devices 150”). Edge devices 150 comprise cloud-managed, wireless local area network (LAN) controllers (WLCs), available as either physical or virtual appliances, integrating cutting-edge AI-driven network capabilities. More specifically, each of edge devices 150 provides a centralized data plane for NAS devices 108 across two or more sites 106 of network 134 with access to a cloud-based control plane provided by NMS 130.

Each of edge devices 150 may comprise an on-premises device that is in communication with NMS 130 to extend certain microservices from NMS 130 to the on-premises NAS devices 108 while using NMS 130 and its distributed software architecture for scalable and resilient operations, management, troubleshooting, and analytics. Edge devices 150 may establish layer 2 tunneling protocol (L2TP) tunnels to securely extend virtual local area networks (VLANs) from edge devices 150 to connected APs 146 for selected WLANs, enabling secure and flexible network architectures. In some scenarios, the WLANs may be configured based on predefined, easily deployable WLAN configurations for consistency, efficiency, and simplified management across different locations.

As one example, edge device 150A comprises a site-level edge device located at site 102A configured to tunnel only traffic for APs 142A of site 102A. As another example, edge device(s) 150B comprise customer organization-level edge device(s) located in an organization's data center and configured to tunnel traffic for APs 142 across two or more sites, e.g., sites 102B-102N. In some scenarios, edge device(s) 150B may comprise an edge cluster that includes a single edge device or multiple edge devices to provide high availability and load balancing. An edge cluster enables high availability, redundancy, and load balancing by grouping multiple edge devices ensuring continuous and uninterrupted network operation.

Each one of the network devices of network system 100, e.g., servers 110, 116, 122 and/or 128, APs 142, switches 146, client devices 148, edge devices 150, and any other servers or devices attached to or forming part of network system 100, may include a system log or an error log wherein each one of these network devices records the status of the network device including normal operational status and error conditions. Throughout this disclosure, one or more of the network devices of network system 100, e.g., servers 110, 116, 122 and/or 128, APs 142, switches 146, and client devices 148, may be considered “third-party” network devices when owned by and/or associated with a different entity than NMS 130 such that NMS 130 does not obtain, collect, or otherwise have access to the recorded status and other data of the third-party network devices. In some examples, edge devices 150 may provide a proxy through which the recorded status and other data of the third-party network devices may be reported to NMS 130.

In some examples, NMS 130 monitors network data 137, which may include statistical data and/or event data, obtained from wireless networks 106A-106N at each site 102A-102N, respectively, and manages network resources, such as APs 142 and switches 146 at each site, to deliver a high-quality wireless experience to end users, IoT devices and clients at the site. For example, NMS 130 may include a virtual network assistant (VNA) 133 that implements an event processing platform for providing real-time insights and simplified troubleshooting for IT operations, and that automatically takes corrective action or provides recommendations to proactively address network issues. VNA 133 may, for example, include an event processing platform configured to process hundreds or thousands of concurrent streams of network data 137 from sensors and/or agents associated with APs 142, switches 146, edge devices 150, and/or other nodes within network 134.

In the illustrated example of FIG. 1A, VNA 133 of NMS 130 includes an anomaly detection unit 152 and a root cause analysis unit 154 that operate as an underlying analytics and network error identification engine and alerting system in accordance with various examples described herein. Anomaly detection unit 152 of VNA 133 may apply historical data and models to the inbound event streams to compute assertions, such as identified anomalies or predicted occurrences of events constituting network error conditions. Further, VNA 133 may provide real-time alerting and reporting to notify a site or network administrator via admin device 111 of any predicted events, anomalies, trends, and may perform root cause analysis and automated or assisted error remediation. In some examples, root cause analysis unit 154 of VNA 133 may apply machine learning techniques to identify the root cause of error conditions detected or predicted from the streams of network data 137. If the root cause may be automatically resolved, VNA 133 may invoke one or more corrective actions to correct the root cause of the error condition, thus automatically improving the network functionality and also automatically improving the user experience.

In operation, NMS 130 observes, collects and/or receives network data 137, which may take the form of data extracted from messages, counters, and statistics, for example. In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of the NMS 130, may execute on other servers or execution environments, or may be distributed to nodes within network 134 (e.g., routers, switches, controllers, gateways, and the like).

Although NMS 130 may obtain network data from, and thus have visibility into, each of NAS devices 108 individually, some problems-especially those at an organizational or site-wide scale-only become apparent when viewing aggregated data across all devices. Edge devices 150 aggregate this data, surfacing issues that might be invisible at the per-device level. However, large volumes of network data with daily and weekly cycles, combined with irregular anomalies, make analysis complex. In addition, performing real-time anomaly detection and root cause identification, while essential to identify and remediate network anomalies, is challenging.

In accordance with one or more techniques of this disclosure, NMS 130 is configured to perform traffic anomaly detection and root cause analysis based on network data 137 obtained from network edge device 150A or 150B. NMS 130 obtains network data 137 for the plurality of NAS devices 108 across two or more sites 102 from network edge device 150B. Network data 137 includes usage statistics 140 for NAS devices 108, including aggregate usage statistics and/or average usage statistics for the plurality of NAS devices 108 across the two or more sites 102. Anomaly detection unit 152 predicts usage statistics at network edge device 150B for a time window in accordance with a pattern or seasonality identified in usage statistics 140 for the plurality of NAS devices 108. Anomaly detection unit 152 detects an anomaly in the usage statistics for the time window based on a difference between actual usage statistics observed at network edge device 150B for the time window and the predicted usage statistics for the time window. Root cause analysis unit 154 then determines a root cause of the detected anomaly based on a type of the detected anomaly.

The disclosed techniques may provide one or more advantages and/or practical applications. Because edge device 150B may be used across two or more sites 102 and reports aggregated and/or average data for the plurality of NAS devices 108 within the two or more sites 102, NMS 130 may need to apply different analysis techniques to and/or may determine different insights from the aggregated and/or average data than network data or usage statistics obtained directly from each of the NAS devices 108 at each of the sites 102. Namely, the aggregated and/or average data obtained by NMS 130 from edge device 150B provides customer enterprise- or organization-level insights that may not be determined from device-level data. For example, usage statistics 140 may comprise aggregate traffic statistics for the plurality of NAS devices 108 across the two or more sites 102, an average number of tunnels established between the plurality NAS devices 108 across the two or more sites 102 and a tunnel terminator at the network edge device 150B, and an aggregate client count of wired and/or wireless clients 148 across the two or more sites 102 connected to the network edge device 150B. The average number of tunnels is indicative of a number of NAS devices 108, e.g., APs 142, connected to the edge device 150B at a customer organization-level. Anomaly detection unit 152 and root cause analysis unit 154 may detect an anomaly and corresponding root cause based on aggregate packet drops, aggregate traffic errors, and/or aggregate traffic spikes in the traffic carried via the tunnels between NAS devices 108 and edge device 150B, a drop or spike in the average number of tunnels between NAS devices 108 and edge device 150B, and/or a drop or spike in the aggregate client count.

Anomaly detection unit 152 may perform forecasting using a machine learning model (e.g., bidirectional long short-term memory (LSTM)) to predict the usage statistics or aggregated network metrics, effectively capturing the traffic pattern or seasonality. Anomaly detection unit 152 may also perform anomaly scoring to evaluate deviations by calculating robust per-feature z-scores and consolidating the z-scores into a unified severity score indicative of a severity of the anomaly, and calculating an importance score indicative of how important the anomaly may be to report to a customer organization. Anomaly detection unit 152 may be configured to provide special handling for the average number of tunnels usage statistic (which may also be referred to as a tunnel size metric or AP count metric) by employing specialized anomaly detection techniques (such as change-point detection or exponentially weighted moving average (EWMA)) to capture sudden shifts in AP connectivity. Anomaly detection unit 152 may also perform anomaly reporting by outputting or delivering detected anomalies back to VNA 133 and/or root cause analysis unit 154 for proactive troubleshooting and root cause analysis.

Based on the traffic anomaly detection and root cause analysis at the network edge, VNA 133 may perform proactive issue detection for the network. For example, VNA 133 may identify link congestion, misconfigured policies, or faulty hardware before user complaints. In addition, root cause analysis unit 154 of VNA 133 may perform root cause analysis after an anomaly is detected by drilling down on specific signals (e.g. error rates vs. AP count) to pinpoint a failing component. VNA 133 may also provide service level agreement (SLA) assurance to maintain performance SLAs by auto-generating tickets on abnormal traffic patterns. VNA 133 may further enable capacity planning based on monitoring long-term shifts in client counts and AP usage trends.

Although the techniques of the present disclosure are described in this example as performed by NMS 130, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NMS 130, or may be distributed throughout network 100, and may or may not form a part of NMS 130.

FIG. 1B is a block diagram illustrating further example details of the network system of FIG. 1A. In the example shown in FIG. 1B, a customer organization includes at least three sites 102A-102N arranged in a “hub and spoke” architecture with switches 146 of sites 102 connected to a “hub” router 170A of network 134. As an example, the customer organization may be a large corporation with multiple campuses, where each campus may be a site. A site may refer to a geographic location. The customer organization may have sites in different cities, sites that are different campuses within a city, sites that are different buildings within a campus, etc. In some examples, network topologies other than hub and spoke may be used. For example, the network may be a partial mesh topology, a full mesh topology, or other network topology. Further, the network topology may be a hybrid topology. Router 170A is configured to communicate with network 134 and router 170B further up the stack toward application services 182 in data center 180.

FIG. 1B illustrates logical connections (shown as dotted lines) for control or management traffic between each of APs 142 at sites 102, edge device 150A at site 102A, and edge device(s) 150B at data center 180, and NMS 130. NMS 130 is configured to provide configuration and management of one or more of APs 142 and edge devices 150 via the logical connections.

FIG. 1B further illustrates tunnels (shown as bold, dashed lines) established between each of APs 142 of sites 102 and either edge device 150A or edge device 150B. For example, each of APs 142A-1 through 142A-M in site 102A have established tunnels with edge device 150A of site 102A. Edge device 150A comprises a site-level edge device located at site 102A configured to tunnel only traffic for APs 142A of site 102A.

As another example, each of APs 142B-1 through 142B-M in site 102B and each of APs 142N-1 through 142N-M have established tunnels with edge device 150B in data center 180. Edge device(s) 150B comprise customer organization-level edge device(s) located in an organization's data center 180 and configured to tunnel traffic for APs 142 across two or more sites, e.g., sites 102B-102N. In some scenarios, edge device(s) 150B may comprise a cluster that includes a single edge device 150B or multiple edge devices 150B to provide high availability and load balancing.

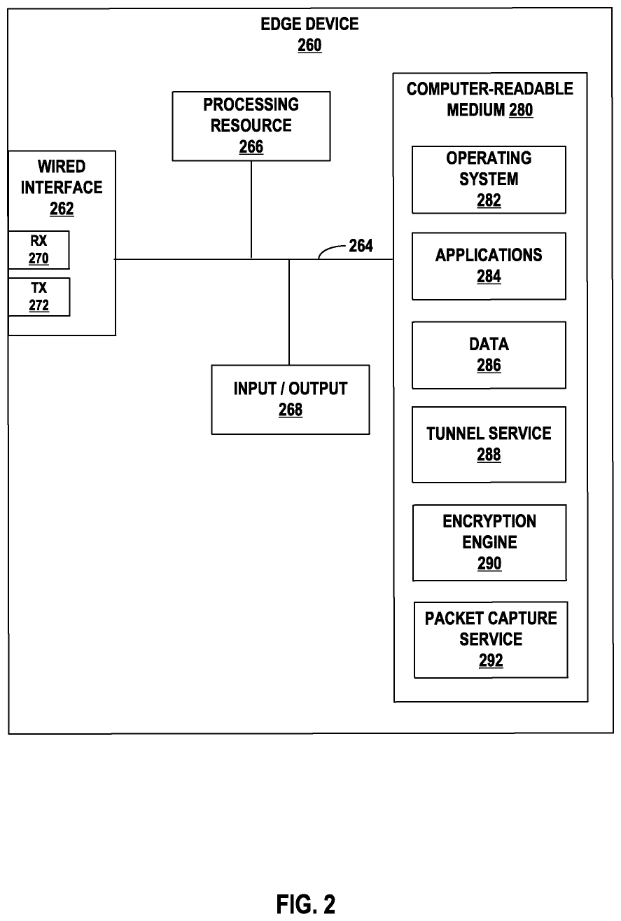

FIG. 2 is a block diagram illustrating an example edge device 260, in accordance with one or more techniques of this disclosure. Edge device 260 may be used to implement, for example, any of edge devices 150 from FIGS. 1A-1B. In such examples, edge device 260 comprises an on-premises device at a site, e.g., site 102A, or at a data center 180 that is in communication with NMS 130 and one or more on-premises NAS devices 108, e.g., one or more APs 142 or switches 146 from FIGS. 1A-1B.

In some examples, edge device 260 is an AI-native networking appliance designed to extend centralized networking services to the edge of the network, such as campus networks or branch offices. Edge device 260 provides a centralized data plane for NAS devices of two or more sites of a network, e.g., an enterprise network, with access to a cloud-based control plane provided by a network management system (NMS). Unlike traditional WLCs, edge device 260 integrates modern AI-driven capabilities and cloud management, efficiently addressing critical challenges associated with managing NAS devices, such as APs, switches, and router, at distributed locations.

Positioned strategically at the network edge, before the gateway, edge device 260 performs several critical roles. As one example, edge device 260 provides a centralized data path such that edge device 260 acts as a central point for managing user traffic, similar to legacy wireless controllers but enhanced with AI and cloud-based management, significantly simplifying the management and operational complexities inherent in distributed networks. As another example, edge device 260 provides VLAN extension such that edge device 260 facilitates VLAN extensions to distributed geographical locations without traditional VPN complexities, ensuring secure and efficient remote access. As a further example, edge device 260 provides network segmentation such that edge device 260 enables dynamic isolation of various traffic types, including IoT and guest traffic, thereby enhancing security and optimizing network performance. As another example, edge device 260 provides security controls such that edge device 260 provides robust traffic isolation, automated deployment of security policies, and secure, encrypted communication channels, mitigating risks and ensuring compliance. As a further example, edge device 260 provides microservices deployment such that edge device 260 simplifies and accelerates the deployment, management, and updates of microservices and critical network functions.

Edge device 260 may provide one or more benefits. As one example, edge device 260 provides agility to rapidly deploy and update network services and features, enabling networks to swiftly respond to evolving business needs. As another example, edge device 260 provides scalability by being designed for versatile deployment scenarios, from small branch offices to expansive campuses, facilitating effortless scaling as network demands grow. As a further example, edge device 260 provides simplicity as zero-touch provisioning and cloud-based management significantly simplify operations, reducing operational complexity and lowering total cost of ownership. As another example, edge device 260 provides insight through rich analytics and visibility into network performance through SLE metrics, allowing network administrators to proactively detect and resolve potential issues.

Edge device 260 has a larger scope than a typical network device, such as a switch, within a single site. Because edge device 260 may be used across two or more sites and reports aggregated network data for the plurality of NAS devices across the two or more sites, the aggregated network data provides increased visibility into traffic anomalies within each site and across the two or more sites and increased visibility into correlations between behavior and events experienced at the plurality of NAS devices over time.

In this example, edge device 260 includes a wired interface 262, e.g., an Ethernet interface, one or more processing resource 266, input/output devices 268, e.g., display, buttons, keyboard, keypad, touch screen, mouse, etc., and a computer-readable medium 280 coupled together via a bus 264 over which the various elements may interchange data and information. Wired interface 262 couples edge device 260 to a network, e.g., an enterprise network and/or any local area networks. Wired interface 262 includes a receiver 270 and a transmitter 272 by which edge device 260 receives/transmits data and information to/from any of NAS devices and an NMS. Though only one interface is shown by way of example, edge device 260 may have multiple communication interfaces and/or multiple communication interface ports.

Processing resource 266 includes one or more programmable hardware-based processors (e.g., Central Processing Units (CPUs), Graphics Processing Units (GPUs), Digital Signal Processors (DSPs), microprocessors, controllers, Application-Specific Integrated Circuits (ASICs), Field-Programmable Gate Arrays (FPGAs), quantum processors, or other equivalent integrated or discrete logic circuitry) configured to execute software instructions, such as those used to define a software or computer program, stored to a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause processing resource 266 to perform the techniques described herein.

Input/output (I/O) devices 268 represents physical hardware components that enable interaction with a user, such as buttons, a display, and the like. Although not shown, computer-readable medium 280 typically stores executable software for controlling a user interface with respect to input received via I/O devices 268.

Computer-readable medium 280 includes one or more devices configured to store programming units and/or data associated with operation of edge device 260 (e.g., operating system, executable software applications 284, data 286, tunnel service 288, encryption engine 290, and packet capture service 292 in the example of FIG. 2). For example, computer-readable medium 280 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processing resource 266 to perform the techniques described herein.

In the example of FIG. 2, computer-readable medium 280 stores operating system 282, executable software applications 284, and data 286. Data 286 may include a system log and/or an error log that stores event data, including behavior data, for edge device 260. Data 286 may include any data used and/or generated by edge device 266, including data collected from NAS devices across two or more sites, that is transmitted by edge device 266 to the NMS.

Edge device 260 provides tunnel service 288 to a plurality of NAS devices across the two or more sites such that edge device 260 may monitor traffic of the NAS devices and/or control routing of the traffic to/from the NAS devices. Edge device 260 maintains a secure connection with the NMS and reports network data, e.g., usage statistics of the monitored traffic for the NAS devices aggregated across the two or more sites and/or event data, to the NMS.

Tunnel service 288 provides on-premises tunnel termination at edge device 260 from APs and other NAS devices. In some examples, tunnel service 288 supports L2TP and establishes L2TP tunnels with the plurality of NAS devices, e.g., APs, across the two or more sites for selected WLANs. In these examples, tunnel service 288 may operate as a tunnel terminator of L2TP network server (LNS) at edge device 260. Tunnel service 288 enables tunneling of network traffic to/from the NAS devices and also enables tunneling of a corporate service set identifier (SSID) to edge device 260 deployed in a data center. In this way, edge device 260 may access corporate resources.

In other examples, tunnel service 288 may operate as a secure tunnel proxy to the NMS and/or NAC systems. In one scenario, one or more of the NAS devices may not support establishment of secure tunnels, e.g., WebSocket or RadSec tunnels, directly with the NMS and/or the NAC systems. In this scenario, tunnel service 288 of edge device 260 provides a tunnel proxy to, e.g., enable authentication requests received from a NAS device to be securely tunneled off premises to the NMS and/or a NAC system.

Encryption engine 290 provides encryption of data transported via the tunnels established by tunnel service 288 of edge device 260. For example, encryption engine 290 may support Internet Protocol Security (IPSec) to provide encryption and security to data packets encapsulated within L2TP tunnels.

Packet capture service 292 provides capture of the network traffic for the plurality of NAS devices tunneled to edge device 260. To help diagnose customer network problems, edge device 260 uses packet capture service 292 to supplement conventional data path drop counters with the headers of the dropped packets. Since a lot of packets may be dropped at edge device 260 and since not all dropped packets are needed for diagnosis or root cause analysis, packet capture service 292 does not capture all of the dropped packet headers for reporting to the NMS. Instead, packet capture service captures or samples enough dropped packets to enable the NMS to determine the most common drop reasons and/or the most frequent source and/or destination address of dropped packets without overloading the data path or cloud bandwidth.

Packet capture service 292 keeps track of one dropped packet per drop reason, per data path CPU core. The tracked packet is randomly replaced as more drops happen, with probability 1/<num dropped>, so what is sampled is a randomly chosen packet out of all those dropped by this data path CPU core, e.g., based on a hash function or a pseudo-random operation. It should be noted, which data path CPU core processes a packet is determined by a hash of the packet headers at ingress, which is effectively random.

Packet capture service 292 periodically reads out these sampled packets and resets the sampling. For example, this may happen once per second. Packet capture service 292 decodes the packet headers, decides what to keep, and accumulates the packets in per-drop-reason lists. Packet capture service 292 also, on a different timer, periodically summarizes the packets it read out, grouped by drop reason, and inserts that into a message it sends to the NMS. The summary may have multiple parts, e.g., a list of up to N (configurable, MaxRandom, default 0) randomly selected packet headers, the most commonly seen packet out of the set sampled, and the most common value for each packet header. Once this summary is sent to the NMS, packet capture service 292 resets its lists of dropped packets, and resumes reading them out from the data path.

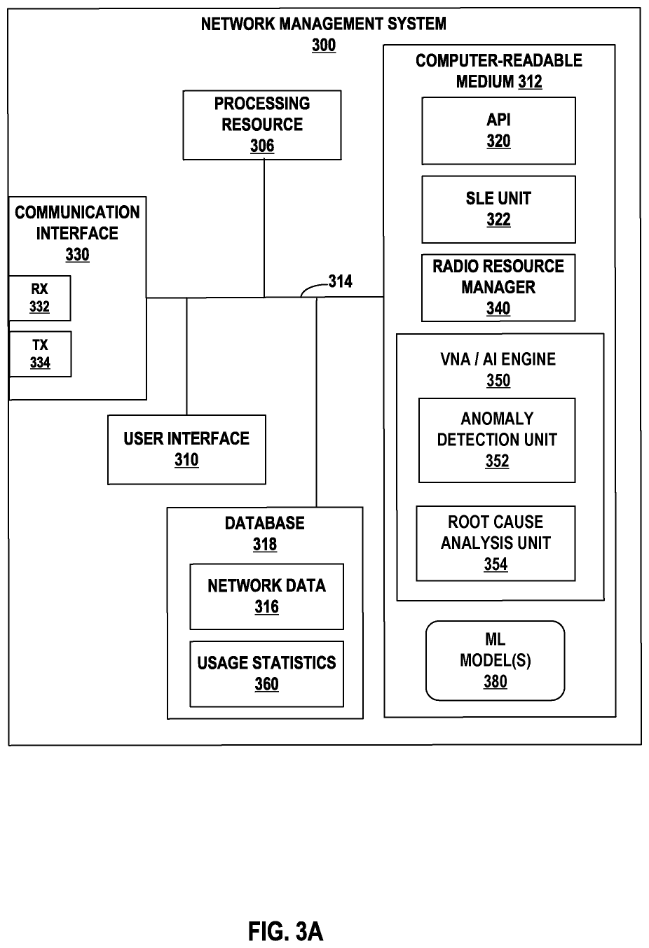

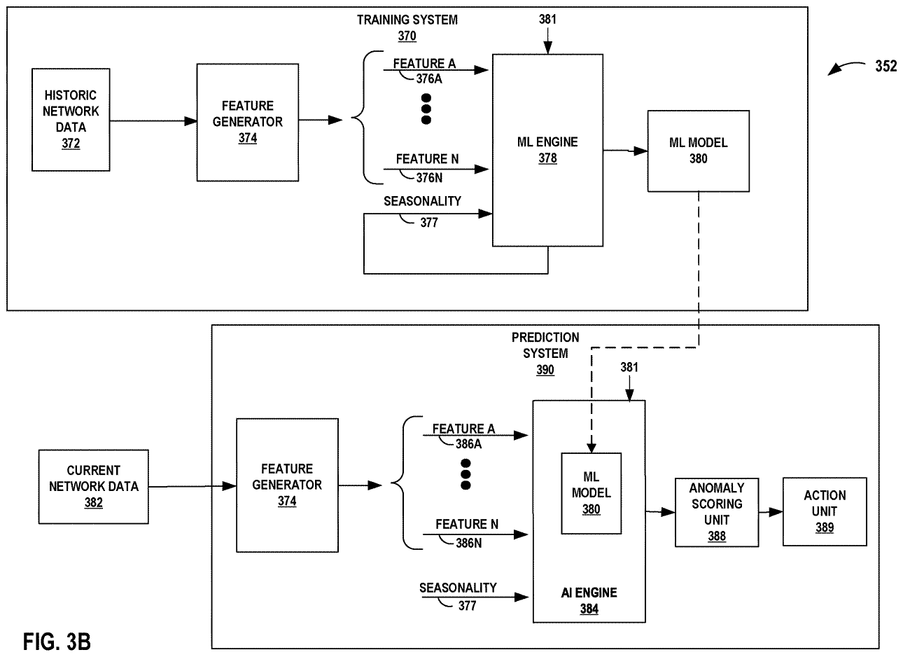

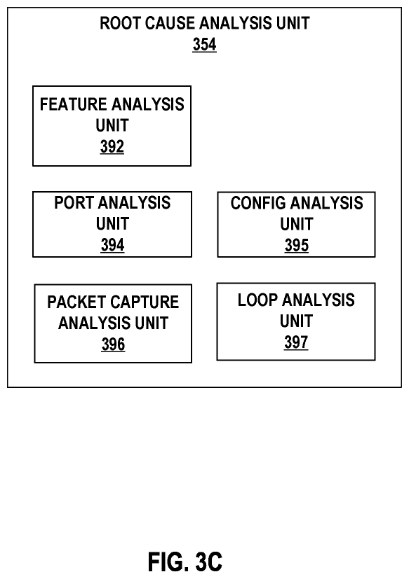

FIG. 3A is a block diagram of an example network management system (NMS) 300, in accordance with one or more techniques of the disclosure. NMS 300 may be used to implement, for example, NMS 130 from FIGS. 1A-1B. In such examples, NMS 300 is responsible for monitoring and management of one or more wireless networks 106 at sites 102 from FIGS. 1A-1B.

NMS 300 includes a communications interface 330, one or more processing resource 306, a user interface 310, a computer-readable medium 312, and a database 318. The various elements are coupled together via a bus 314 over which the various elements may exchange data and information. In some examples, NMS 300 receives data from one or more of client devices, APs, switches, routers, edge devices, and other network nodes within the network, which may be used to calculate one or more SLE metrics and/or update network data 316 in database 318. In some examples, network data 316 may be substantially similar to network data 137 of FIG. 1A. NMS 300 analyzes this data for cloud-based management of wireless networks and, in some cases, portions of the wired network and wide area network (WAN).

Processing resource 306 executes software instructions, such as those used to define a software or computer program, stored to a computer-readable storage medium (such as computer-readable medium 312), such as non-transitory computer-readable mediums including a storage device (e.g., a disk drive, or an optical drive) or a memory (such as Flash memory or RAM) or any other type of volatile or non-volatile memory, that stores instructions to cause the one or more processing resource 306 to perform the techniques described herein. In the example of FIG. 3, computer-readable medium 312 includes an API 320, an SLE unit 322, a radio resource management (RRM) engine 340, a virtual network assistant (VNA)/AI engine 350, and one or more machine learning (ML) models 380.

Communications interface 330 may include, for example, an Ethernet interface. Communications interface 330 couples NMS 300 to a network, e.g., an enterprise network, the Internet, and/or any local area networks. Communications interface 330 includes a receiver 332 and a transmitter 334 by which NMS 300 receives/transmits data and information to/from any of client devices, APs, switches, edge devices, routers, servers, and/or any other network nodes, devices, or systems forming part of the network system. In some scenarios described herein in which the network system includes “third-party” network devices that are owned and/or associated with different entities than NMS 300, NMS 300 does not receive, collect, or otherwise have access to network data from the third-party network devices.

The data and information received by NMS 300 may include, for example, telemetry data, SLE-related data, or event data received from one or more of client devices, APs, switches, edge devices, routers, or other network nodes used by NMS 300 to remotely monitor the performance of wireless networks, portions of the wired network and WAN, and application sessions from client device to cloud-based application server. NMS 300 may further transmit data via communications interface 330 to any network devices such as client devices, APs, switches, edge devices, routers, other network nodes, and/or an admin device to remotely manage wireless networks and portions of the wired network and WAN.

Computer-readable medium 312 includes one or more devices configured to store programming units and/or data associated with operation of NMS 300. For example, computer-readable medium 312 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processing resource 306 to perform the techniques described herein.

In this example, computer-readable medium 312 includes API 320, SLE unit 322, RRM engine 340, and VNA/AI engine 350. In accordance with the disclosed techniques, VNA/AI engine 350 includes anomaly detection unit 352 and root cause analysis unit 354. In some examples, anomaly detection unit 352 may operate substantially similar to anomaly detection unit 152 of FIG. 1A, and root cause analysis unit 354 may operate substantially similar to root cause analysis unit 154 of FIG. 1A. NMS 300 may also include any other programmed units, software engines and/or interfaces configured for remote monitoring and management of wireless networks and portions of the wired network and WAN, including remote monitoring and management of any APs, switches, edge devices, routers, or other network devices.

SLE unit 322 enables set up and tracking of thresholds for SLE metrics for each network 106A-106N, as well as the wired network and WAN. SLE unit 322 further analyzes SLE-related data collected by APs from client devices in each wireless network. For example, APs collect SLE-related data from client devices currently connected to a wireless network. This data is transmitted to NMS 300, which executes SLE unit 322 to determine one or more SLE metrics for each client device currently connected to the wireless network. This data, in addition to any network data collected by the APs in the wireless network, is transmitted to NMS 300 and stored as, for example, network data 316 in database 318.

RRM engine 340 monitors one or more metrics for each site in order to learn and optimize the RF environment at each site. For example, RRM engine 340 may monitor the coverage and capacity SLE metrics for a wireless network at a site in order to identify potential issues with SLE coverage and/or capacity in the wireless network and to make adjustments to the radio settings of the access points at each site to address the identified issues. For example, RRM engine may determine channel and transmit power distribution across all APs in each wireless network. For example, RRM engine 340 may monitor events, power, channel, bandwidth, and number of clients connected to each AP. RRM engine 340 may further automatically change or update configurations of one or more APs at a site with an aim to improve the coverage and capacity SLE metrics and thus to provide an improved wireless experience for the user.

VNA/AI engine 350 analyzes data received from network devices as well as its own data to identify when undesired or abnormal states are encountered at one of the network devices. For example, VNA/AI engine 350 may identify the root cause of any undesired or abnormal states, e.g., any poor SLE metric(s) indicative of connected issues at one or more network devices. In addition, VNA/AI engine 350 may automatically invoke one or more corrective actions intended to address the identified anomalies. Examples of corrective actions that may be automatically invoked by VNA/AI engine 350 may include, but are not limited to, invoking RRM 340 to reboot one or more APs, adjusting/modifying the transmit power of a specific radio in a specific AP, adding SSID configuration to a specific AP, changing channels on an AP or a set of APs, etc. The corrective actions may further include restarting an edge device, a switch or a router; bouncing a port of an edge device, switch, or router; invoking downloading of new software to an AP, edge device, switch, or router; or updating a configuration of an AP, edge device, switch, or router. These corrective actions are given for example purposes only, and the disclosure is not limited in this respect. If automatic corrective actions are not available or do not adequately resolve the root cause, VNA/AI engine 350 may proactively provide a notification including recommended corrective actions to be taken by IT personnel, e.g., a site or network administrator using an admin device, to address the identified anomalies.

In accordance with one or more techniques of this disclosure, VNA/AI engine 350 includes anomaly detection unit 352 configured to detect traffic anomalies based on usage statistics 360 obtained from a network edge device for a plurality of NAS devices, e.g., APs, across two or more sites of a network, e.g., an enterprise network. VNA/AI engine 350 further includes root cause analysis unit 354 configured to determine a root cause of a detected anomaly based on a type of the detected anomaly.

VNA/AI engine 350 may extract usage statistics 360 from network data 316 obtained for the network devices in communication with NMS 300. For purposes of this disclosure, usage statistics 360 may include aggregate usage statistics and/or average usage statistics observed at a network edge device for a plurality of NAS devices across two or more sites. More specifically, usage statistics 360 may include aggregate traffic statistics, such as receive (rx) packets, transmit (tx) packets, rx errors, tx errors, rx overrun errors, and total drops for the plurality of NAS devices. Usage statistics 360 may also include an average number of tunnels established between the plurality NAS devices and a tunnel terminator at the network edge device. Usage statistics 360 may further include an aggregate client count of wired and/or wireless clients, e.g., client devices, connected to the plurality of NAS devices associated with the network edge device. VNA/AI engine 350 may also identify a pattern or seasonality in usage statistics 360 over time that is indicative of seasonality based on time, e.g., day of week and time of day (hour, minute), and/or a number of clients, e.g., client devices, connected to the plurality of NAS devices associated with the network edge device.

As described with respect to FIG. 3B, anomaly detection unit 352 may use one or more of ML models 380 to predict usage statistics for a time window and determine a deviation of actual usage statistics for the time period from one of a minimum value or a maximum value of the predicted usage statistics for the time window. In some examples, ML model 380 may comprise a supervised ML model that is trained, using training data comprising pre-collected, labeled network data received from network devices (e.g., client devices, APs, switches, routers, edge devices, and/or other network nodes), to predict expected usage statistics for a future time window and identify deviations or anomalies in actual usage statistics observed for the time window. The supervised ML model may comprise one of a logistical regression, naïve Bayesian, support vector machine (SVM), recurrent neural network (RNN), bidirectional LSTM, or the like. In other examples, ML model 380 may comprise an unsupervised ML model. In one specific example, ML model 380 may be a multivariate time series model comprising a bidirectional LSTM trained on time-series or sequential usage statistics with embeddings for meta features, such as seasonality, for a particular edge device.

FIG. 3B is a conceptual diagram of anomaly detection unit 352 of the NMS 300 of FIG. 3A. In the illustrated example, anomaly detection unit 352 includes a dedicated training system 370 and a prediction system 390. In some scenarios, the components of training system 370 and prediction system 390 may be included as part of anomaly detection unit 352 of VNA/AI engine 350 within machine-readable medium 312 of FIG. 3A. In other scenarios, training system 370 may be executed by one or more other computing systems to train ML model 380, which is then used by predication system 390 stored within machine-readable medium 312 and executed processing resource 306 of NMS 300.

Training system 370 is configured to train ML model 380 based on training data, e.g., historic network data 372, to determine appropriate weights across one or more features 376A-376N of the training data. Training system 370 includes ML engine 378 configured to use supervised or unsupervised machine learning techniques to generate ML model 380 to predict usage statistics used to detect anomalies in actual usage statistics, which may indicate a network issue. Training system 370 may generate and maintain a unique ML model for each edge device, which may be used across two or more sites. In some examples, training system 370 may train a universal model and then generate fine-tuned models from the universal model for each edge device.

In one example, ML engine 378 uses supervised machine learning techniques to train the ML model 380 to predict usage statistics. For example, feature generator 374 may generate network features 376A-376N based on historic network data 372, e.g., network data obtained for the plurality of NAS devices across two or more sites from the edge device over a first period of time. Network features 376 comprise raw or pre-processed input data of historic network data 372 used to train ML model 380 to make predictions. In this example, network features 376 may represent aggregate usage statistics and/or average usage statistics extracted from historic network data 372. Feature generator 374 may monitor the key metrics or features according to a time series frequency, e.g., a 10-minute interval, aligned across all metrics. Examples of the key metrics or features monitored include:
Traffic Volume: RX/TX packets per AP and aggregated.
Error Rates: Packet errors and overruns indicating hardware or link issues.
Packet Drops: Policy-enforced drops vs. hardware drops.
Client Counts (fdb_in_use): Wired/wireless clients via forwarding database (FDB) table size.
AP Count (tunnels_size): Sudden AP join/leave events impacting load.

Table I, below, provides descriptions and behavior of the example features.

TABLE I

| Feature | Description | Behavior |
|---|---|---|
| eth_ports_rx_pkts | Total incoming packets | Strong daily/weekly |
| | | seasonality |
| eth_ports_tx_pkts | Total outgoing packets | Strong daily/weekly |
| | | seasonality |
| eth_ports_rx_errors | RX packet error counts | Noisy, sparse |
| eth_ports_tx_errors | TX packet error counts | Noisy, sparse |
| eth_ports_rx_{—} | Hardware overruns due | Very noisy |
| overrun_errors | to buffer exhaustion | |
| total_drops | Number of packets | Sparse, skewed, |
| | dropped by policies | sometimes seasonal |
| fdb_in_use | Number of MAC-table | Seasonal, depends |
| | entries (clients) | on usage patterns |
| tunnels_size | Number of APs | Mostly constant, |
| | connected to the Edge | occasional level shifts |

In some examples, feature generator 374 performs some data preparation or pre-processing on the network data, including robust scalar, local outlier detection, and log transformation for drops. Examples of the data preparation or pre-processing may include:
1. Missing Timestamps: feature generator 374 may fill a uniform time interval, e.g., 10-minutes, via forward and/or backward fill.
2. Log Transformation: feature generator 374 may apply log (x+0.5) to certain metrics, e.g., eth_ports_rx_errors, eth_ports_tx_errors, total_drops, to stabilize variance.
3. Rescaling: feature generator 374 may fit robustScaler (quantile_range=(10,95)) on the first 90% of each series to transform all data.
4. Local Outlier Removal: feature generator 374 may apply LocalOutlierFactor (n_neighbors=20) per feature on training split, and replace outliers with rolling mean (window=6) to maintain continuity.
5. Feature Validation: feature generator 374 may drop series with <288 samples or insufficient seasonal fast Fourier transform (FFT) peaks.

Network features 376 may provide input variables for ML model 380 to make predictions about usage statistics for a future period of time. Based on network features 376, ML engine 378 may train the ML model 380 to predict future usage statistics by learning decision rules inferred from network features 376. In some examples, ML engine 378 may incorporate a meta feature 377 representative of a seasonality or pattern of network usage as observed at the edge device. Meta feature 377 comprises a descriptive property of a dataset, such as historic network data 372, or of network features 376 themselves to optimize the learning process of ML model 380. In the illustrated example, seasonality meta feature 377 may include day of week, hour, minute, and a unique ID code.

In some examples, ML engine 378 may incorporate contribution values 381, e.g., Shapley Additive Explanation (SHAP) or Local Interpretable Model-Agnostic Explanations (Lime) values, to provide a way in which to measure the contribution of each network feature 376 to the predicted usage statistics. For example, anomaly detection unit 352 may assign a value to each network feature 376 based on how much the network feature contributes to the predicted usage statistics (e.g., level of contribution). Contribution values 381 are computed by evaluating the predictive model's predictions for all possible subsets of the network features and then taking the average difference in predictions when a particular network feature is added or removed from the subset. In this way, by incorporating contribution values 381 to the ML model 380, anomaly detection unit 352 may identify the network features 376 that have the most significant effect or influence towards the predicted usage statistics.

Feature engineering and windowing of streaming data is described herein with respect to generation of network features 376 used to generate ML model 380. Time series data is inherently temporal; sliding windows transform continuous streams into supervised learning examples by:
Capturing local patterns and seasonality (daily/weekly cycles) within a uniform context.
Providing the model with fixed-length historical frames to learn dependencies across time.
Enabling anomaly detection relative to recent behavior instead of global baselines.

Feature generator 374 constructs sliding windows using:
n_recurrence=72 (12 hours of history at 10-minute intervals);
n horizon=6 (next 1 hour, i.e., 6 future steps); and
n_error=6 (window size for computing lower and upper bounds for error margin/confidence interval).

```
Pseudocode:
n_rec, n_hor, n_err = 72, 6, 6
X_vals, X_meta = [ ], [ ]
Y_vals, Y_low, Y_high = [ ], [ ], [ ]
# Build input sequences
for lag in range(n_rec, 0, −1):
  X_vals.append(df[features].shift(lag))
  X_meta.append(df[meta_features].shift(lag))
# Build forecast and error-margin outputs
for j in range(0, n_hor):
  Y_vals.append(df[features].shift(−j)
  if margin:
    Y_low.append(lower_bound.shift(−j))
      Y_high.append(upper_bound.shift(−j))
```

After concatenation and cleanup, feature generator 374 obtains:
Input tensor X: (num_samples, n_recurrence, num_features+num_meta_features)
   Example: (N, 72, 8+4)
Output tensor Y: (num_samples, n_horizon*num_features*3)
   Flattened components: [values, lower bounds, upper bounds] for each horizon.

This structured windowing ensures ML model 380, e.g., bidirectional LSTM, receives consistent, context-rich input and outputs predictions with uncertainty margins for robust anomaly detection.

After constructing X_input and Y_input, feature generator 374 splits chronologically to preserve temporal order. With this split, ML model 380 learns from the first 90% of sliding windows and is validated on the most recent 10%, accurately simulating production conditions.

An example model architecture for ML model 380 as a bidirectional LSTM is described herein. ML model 380 may include input layers.
Numerical Features (feature_input): 3D tensor of shape (batch_size, timesteps=72, num_features=7) representing scaled and imputed traffic signals.
Meta-Feature Inputs: Four separate 2D inputs of shape (batch_size, timesteps) for day-of-week, hour, minute, and unique ID, each passed through its own embedding layer.

ML Model 380 may also include embedding layers.

For each meta feature, we learn a compact vector representation:
day_emb=Embedding (input_dim=7, output_dim=5) (day_input)
hour_emb=Embedding (input_dim=24, output_dim=5) (hour_input)
min_emb=Embedding (input_dim=6, output_dim=5) (minute_input)
id_emb=Embedding (input_dim=uid_cardinality, output_dim=5) (id_input)

Each embedding produces a 3D tensor (batch_size, timesteps, embed_dim=5).

The numerical history and all embeddings along the features axis at each time step are merged:
#Concatenate along last dimension:
x=concatenate ([feature_input, day_emb, hour_emb, min_emb, id_emb], axis=−1)
#Resulting shape: (batch_size, 72, 8+4*5=28)

ML model 380, as a bidirectional LSTM, processes the sequence in both forward and backward temporal directions, capturing past and future context within the window:
1. Layer 1:
   X=Bidirectional (LSTM (units=70, return_sequences=True)) (x)
   return_sequences=True retains the full sequence output (batch_size, 72, 140) (70 forward+70 backward).
2. Optional Attention:
   x=Attention ( ) [x, x])
   Allows the model to weight important time steps dynamically.
3. Layer 2:
   x=Bidirectional (LSTM (units=70)) (x)
   Collapses to final context vector of shape (batch_size, 140) summarizing both directions.

Bidirectional LSTM may be selected for ML model 380 based on:
Symmetric context: Learns dependencies from both ends of the history window.
Seasonality capture: Effective at modeling repeating daily/weekly patterns by seeing both past and “future” within the fixed window.

After obtaining the context vector:
x=Dropout (rate=0.3) (x) #Regularization
output=Dense (units=n_horizon*3*num_features) (x)
units=144 for 6 horizons×3 (value, lower, upper)×8 features.
Output shape: (batch_size, 144).

An example model summary for ML model 380 follows.
model=Model (inputs=[day_input, hour_input, minute_input, id_input, feature_input], outputs=output)
model.compile (optimizer=Adam (learning_rate=Ir_schedule, amsgrad=True), loss=Huber( ))
model.summary ( )

### Key Characteristics:

Bidirectionality: Captures full-window dependencies.
Embedding Fusion: Enriches numeric signals with time-of-day and device identity context at each step.
Uncertainty Bounds: Predicts both point estimates and error margins for robust anomaly detection.

Loss functions and custom metrics for ML model 380 are described herein. In some examples, ML engine 378 may use Huber loss for training ML model 380 for one or more of the following reasons.
Robust to Outliers: For small residuals, Huber loss uses a squared error (like MSE), which encourages precise fitting. For large residuals, it switches to absolute error (like MAE), limiting the impact of extreme anomalies on the gradient.
Stable Gradients: The built-in transition point (delta) ensures a smooth, continuous gradient, preventing the large-gradient spikes that can occur with pure MSE when outliers are present.
Balanced Behavior: This combination leads to faster convergence and better generalization when the data contains noise or occasional spikes.

During inference, ML engine 378 may evaluate both point accuracy and the quality of predicted uncertainty bounds:
1. Extract Predictions and Bounds:
   v_true and v_pred: true and forecasted values
   I_pred and u_pred: predicted lower and upper confidence bounds
2. Compute Violations:
   upper_violation=max (0, v_true−u_pred)
   lower_violation=max (0, I_pred−v_true)
3. Combine into Loss:
   def edited_serving_band_error_loss (y_true, y_pred, features, noisy_features):
#Slice true values and predicted bands
v_true=y_true [:,: n_feats]
v_pred=y_pred [:,: n_feats]
I_pred=y_pred [:, n_feats: 2*n_feats]
u_pred=y_pred [:, 2*n_feats: 3*n_feats]
#Calculate band violations
upper_violation=tf.maximum (v_true−u_pred, 0.0)
lower_violation=tf.maximum (l_pred−v_true, 0.0)
#Optionally mask out lower violations for specified noisy features
#lower_violation=tf.where (mask, 0.0, lower_violation)
band_violation=upper_violation+lower_violation
band_loss=tf.reduce_mean (tf.square (band_violation), axis=1)
point_loss=tf.reduce_mean (tf.square (v_pred-v_true), axis=1)
return band_loss+point_loss

### Rationale:

Uncertainty Quality: Directly penalizes cases where true observations fall outside predicted bounds, improving interval calibration.
Aligns with Anomaly Goals: Since anomalies are triggered by out-of-band events, optimizing this loss reduces false alarms and missed detections.
Flexible Masking: Exclude certain features from lower-band checks to reflect domain knowledge (e.g., noisy error rates).

Hyperparameter tuning and convergence of ML model 380 is described herein.
1. Learning Rate (LR) & Scheduler
   Initial Learning Rate: Set to 0.009 to balance convergence speed and stability.
   Exponential Decay:
      decay_steps=2000 steps smooths the schedule over multiple epochs.
      decay_rate=0.85 gently reduces LR to fine-tune around minima.
      staircase=False enables continuous decay rather than abrupt drops.
   Rationale: A carefully decayed LR avoids overshooting late in training and helps escape shallow local minima early.

```
lr_schedule = ExponentialDecay(
  initial_learning_rate=0.009,
  decay_steps=2000,
  decay_rate=0.85,
  staircase=False
)
optimizer = Adam(learning_rate=lr_schedule, amsgrad=True)
```

2. Optimizer Choice & AMSGrad
   Adam: Adaptive moment estimation combines momentum and RMSProp benefits.
   AMSGrad: Uses a non-increasing step to ensure convergence in worst-case scenarios.
   Why AMSGrad? Provides stronger theoretical guarantees on convergence stable rates when gradients are noisy or sparse.
3. Regularization via Dropout
   Dropout Rate Sweep: Tested between 0.1 and 0.5; settled at 0.3.
   Effect: Prevents co-adaptation of LSTM nodes, reducing overfitting to training windows.
4. Batch Size & Epochs
   Batch Size: Explored [512, 1024, 2048, 4096].
      2048 chosen for efficient GPU utilization and stable gradient estimates.
   Epochs: Up to 50, with EarlyStopping to halt when no improvement.
5. Early Stopping Configuration
   Monitor: val_loss
   Patience: 10 epochs after epoch 15
   Min Delta: 1e-4 to detect meaningful improvements
   Restore Best Weights: Ensures final model is the best seen during training.
   early_stopping:
      monitor: “val_loss”
      min_delta: 0.0001
      patience: 10
      start_from_epoch: 15
      restore_best_weights: true
6. Validation Metrics & Convergence Analysis
   Primary: Validation Huber loss tracks both point accuracy and robust behavior in presence of outliers.
   Secondary: Compute MAPE and RMSE on first-horizon predictions to ensure critical forecasts are accurate.
   Learning Curves: Plot training vs. validation loss per epoch to detect under/overfitting, adjust LR or dropout accordingly.
7. Practical Tips
   Warm-up Phase: Optionally linearly ramp LR from zero to initial_Ir over first few epochs to stabilize early training.
   Gradient Clipping: Clip gradients (e.g., norm≤1.0) to prevent exploding gradients in deep LSTM stacks.
   Checkpoint Frequency: Save model every N steps for recovery in case of interruptions.

By meticulously tuning these hyperparameters and monitoring convergence behavior, ML engine 378 achieves stable training trajectories and robust generalization for production anomaly detection.

After training, ML model 380 may be deployed for use by AI engine 384 of prediction system 390. Feature generator 374 of prediction system 390 may then process current network data 382 (e.g., network data obtained from the plurality of NAS devices across two or more sites from the edge device over a second, subsequent period of time) into network features 386A-386N. Network features 386 comprise raw or pre-processed input data of current network data 382 used by ML model 380 to make predictions. Network features 386 may represent the same type of network features as were used by ML engine 378, e.g., network features 376A-376N, to generate ML model 380 based on historic network data 372, but may represent different values.

AI engine 384 applies network features 386 and seasonality meta feature 377 (and in some examples, contribution values 381) to ML model 380 as input. AI engine 384 subsequently receives output from ML model 380 that may include predicted usage statistics for a third, future period of time that is used to detect anomalies in actual usage statistics observed for the third, future period of time. Anomaly scoring unit 388 applies one or more filters to the detected anomalies to determine whether the anomalies are actionable and/or reportable to the customer organization. If an important, actionable anomaly is detected, action unit 389 may invoke an action, such as outputting a notification to report the detected anomaly to a site or network administrator, e.g., via an admin device, and/or instructing root cause analysis unit 354 to determine a root cause of the detected anomaly.

The seasonality meta feature 377 may be determined based on time, e.g., day of week and time of day (e.g., hour, minute). In further examples, the seasonality meta feature 377 may be based on a number of clients connected to the plurality of NAS devices associated with the edge device. The seasonality meta feature 377 may improve accuracy of ML model 380 in predicting usage statistics that change according to a relatively regular pattern or seasonality depending on the day of week, time of day, and number of clients. For example, usage statistics at offices of a customer organization may be high during weekday mornings when large numbers of clients are attempting to connect to the wireless networks at the two or more sites. Conversely, usage statistics at the offices may be low during nights and/or weekends when few or no clients are connecting to the wireless networks at the two or more sites. In some scenarios, the number of clients may provide a more accurate or more reliable pattern or seasonality of usage than time, particularly for those sites with no identifiable time-based seasonality. The number of clients may indicate a baseline activity level of clients at a particular office or site of the customer organization, e.g., a given site may have highly active clients such that low clients with high traffic would not be considered anomalous behavior for the given site.

In some cases, prior to generating a ML model for a particular edge device and/or applying prediction system 390 to current network data 382 observed at the particular edge device, VNA/AI engine 350 may determine whether there is enough usage at the two or more sites associated with the edge device to generate and/or run the ML model. For example, VNA/AI engine 350 may determine whether a number of clients connected to the plurality of NAS devices associated with the edge device or a number of tunnels established between the plurality NAS devices and the edge device satisfies at least one threshold prior to initiating anomaly detection unit 352 for the edge device.

Training system 370 may train ML model 380, as described above, in batches as an offline process. Prediction system 390, however, may predict the metrics or usage statistics and detect anomalies in real-time based on streaming current network data 382. AI engine 384 may detect anomalies by calculating loss values as the difference between the predicted values and the actual values of network features 386 and identifying the loss values that satisfy (i.e., meet or exceed) a threshold as anomalies. In some examples, AI engine 384 may first calculate an average loss value averaged over all of network features 386 and detect an anomaly when the average loss satisfies a global threshold. This anomaly detection scheme may result in a large number of detected anomalies due to inaccuracies in the average values and/or global thresholds. Reporting and/or reacting to each of the large number of detected anomalies may be impractical and/or impossible in the case of real-time anomaly detection in streaming data. According to the disclosed techniques, for each detected anomaly, anomaly scoring unit 388 determines a severity score based on per-feature loss values and per-feature weights for network features 386. Anomaly scoring unit 388 may then determine that the severity score of the anomaly is indicative of a severe or actionable anomaly, e.g., when the severity score is equal to or greater than 60%.

For example, prediction system 390 of anomaly detection unit 352 may use current network data 382 observed during a first time window (e.g., the last 3 hours, last 6 hours, or last 12 hours in 10-minute intervals) as input to ML model 380 to predict usage statistics for a second, future time window (e.g., the next 1 hour). AI engine 384 detects an anomaly based on the average loss (i.e., the difference between the expected or predicted usage statistics for the second time window and actual usage statistics observed at the edge device during the second time window averaged over network features 386) satisfying the global threshold. AI engine 384 also calculates the per-feature loss values for each of network features 386 (e.g., a list of loss values for network features 386). Each feature of network features 386 may have a different loss function unique to the feature. For example, AI engine 384 may determine a deviation from one of a minimum value or a maximum value of the predicted usage statistics for some of features 386 and may determine a deviations from both the minimum and maximum values of the predicted usage statistics for others of features 386.

For the detected anomaly, anomaly scoring unit 388 determines the severity score. Anomaly scoring unit 388 may first calculate a per-feature z-score for each of network features 386 that provides a standardized amount of deviation of the per-feature loss value from a per-feature global threshold (e.g., 99th percentile) to identify large anomalies. Anomaly scoring unit 388 then determines the severity score by multiplying each per-feature z-score by the per-feature weight and summing the products for all of network features 386. The per-feature weights may be determined based on a SHAP analysis and/or based on domain expertise. The per-feature weights indicate different levels of importance assigned to each of network features 386. For example, the number of tunnels or tunnel size feature may be the most important feature while the packet drops may be less important. The per-feature weights may add up to 1 across all of network features 386. Anomaly scoring unit 388 determines that the detected anomaly is an actionable anomaly based on the severity score satisfying a configurable limit, e.g., 60%. In this way, action unit 389 may report or output a notification of the detected anomaly to a site or network administrator, e.g., via an admin device, and/or instruct root cause analysis unit 354 to determine a root cause of the detected anomaly when the detected anomaly is determined to be an actionable anomaly based on the severity score.

The steps of the z-score pipeline are described herein. In the anomaly detection framework, prediction system 390 generates detailed loss metadata per timestamp and feature, then derives adaptive local and global thresholds, z-scores, and a unified severity metric as follows:

### 1. Metadata Collection

Per feature Band Error Loss: After inference, compute loss at first horizon for each feature, yielding loss_pf of shape (N, F).
Per sample Average Loss: loss_avg [j]=(1/F)*Σ{i=1}\hat{ }{F} loss_pf [j,i].

### 2. Local (Edge Level) Statistics

Median & Diff:
   med_loc [i]=median_j (loss_pf [:,i])
   diff_loc [j, i]=loss_pf[j,i]−med_loc [i]
Average Median & Diff:
   med_avg_loc=median_j (loss_avg [j])
   diff_avg_loc [j]=loss_avg [i]-med_avg_loc
Thresholds & Spreads:
   Local 95th/99th percentiles
   T_loc95 [i]=percentile (diff_loc [:, i], 95),
   T_loc99 [i]=percentile (diff_loc [:, i], 99)
   Local IQR:
   IQR_loc [i]=percentile (diff_loc [:, i],75)—percentile (diff_loc [:, i],25)
   Same for average: T_avg_loc99=percentile (diff_avg_loc,99),
   IQR_avg_loc=percentile (diff_avg_loc,75)—percentile (diff_avg_loc,25).

### 3. Global (Fleet Wide) Statistics

Pool diff_loc across all edges: diff_glb.
Global thresholds & spreads:
T_glb99 [i]=percentile (diff_glb [:,i], 99),
IQR_glb [i]=percentile (diff_glb [:,i],75)—percentile (diff_glb [:,i],25)
Similarly: T_avg_glb99, IQR_avg_glb for average losses.

### 4. Effective Threshold & Spread

To avoid overly tight thresholds or zero spreads:
T_eff [i]=max (T_loc99 [i], T_glb99 [i])
S_eff [i]=max (IQR_loc [i], 0.5*IQR_glb [i], E)
T_eff_avg=max (T_avg_loc99, T_avg_glb99)
S_eff_avg=max (IQR_avg_loc, 0.5*IQR_avg_glb, ¿)

Here, ϵ (e.g., 1e-3) ensures a minimum denominator.

### 5. Z Score Computation

Per feature z score:
z [j, i]=max (0, diff_loc [j, i]-T_eff [i])/S_eff [i]
Average z score:
z_avg [j]=max (0, diff_avg_loc [j]-T_eff_avg)/S_eff_avg

### 6. Severity Fusion

Combine feature contributions into a single anomaly score:
severity [j]=Σi (w·z[j,;])
w: feature weights (from SHAP or domain expertise), Ew_i=1.

### 7. Method Rationale

Granularity: Pinpoints which features drive anomalies via per feature z scores.
Robustness: Median and IQR resist distortion from extreme outliers.
Adaptivity: Merges local edge behavior with fleet wide norms for consistent, context aware detection

In some examples, anomaly scoring unit 388 may further determine an importance score indicative of how important an anomaly may be to report to a customer organization. For example, anomaly scoring unit 388 may compute an anomaly importance score based, at least in part, on a type of ML model 380 and the feature having the largest contribution to the anomaly, such that certain model types and certain anomalous features carry a higher level of importance to report to the customer organization. In some cases, anomaly scoring unit 388 may compute the importance score only for those anomalies determined to be actionable anomalies, as described above. Anomaly scoring unit 388 may use the anomaly importance score to filter or gate which anomalies to report to the customer organization. Anomaly scoring unit 388 determines that the anomaly is an important anomaly based on the importance score satisfying a gating threshold, e.g., approximately 60 or greater than 60 for a bounded importance score interval of [0, 100]. In this way, action unit 389 may report or output a notification of the detected anomaly to a site or network administrator, e.g., via an admin device, and/or instruct root cause analysis unit 354 to determine a root cause of the detected anomaly when the detected anomaly is determined to be important to the customer organization based on the importance score.

In one more specific example, anomaly scoring unit 388 may compute a bounded anomaly importance score for a detected anomaly based on: (i) a model type, (ii) a model-computed importance value and an importance threshold, and (iii) a per-feature contribution map. In the scenario where the model type corresponds to a baseline detector, anomaly scoring unit 388 may set the importance score to a fixed value. In one example, the fixed value for the baseline detector is a constant value equal to approximately 40 for a bounded importance score interval of [0, 100]. In the scenario where the model type corresponds to a learned detector and anomaly details indicate a tunnel size feature as anomalous, anomaly scoring unit 388 may set the importance score to a predetermined high value. In one example, the predetermined high value for the tunnel size condition is about 80 and the learned detector comprises a lightweight neural network-based detector executed from a portable model file. As used herein, learned detector refers to any machine-learned model (e.g., neural networks) executed from a serialized or portable format on an edge or server platform.

In other scenarios, anomaly scoring unit 388 may compute a base component by mapping a margin above the threshold into a capped range, the base component increasing with a non-negative difference between the importance value and the threshold and being limited to a first maximum. In one example, anomaly scoring unit 388 may compute the base component by determining the non-negative difference between the importance value and the threshold, scaling the difference by a factor relative to the threshold, and capping the result at the first maximum of about 50 points.

Anomaly scoring unit 388 may then compute a contribution component using a dominant feature selected from the per-feature contribution map based on a largest contribution value, the contribution component being proportional to a ratio of the dominant contribution to the importance value and limited to a second maximum. In one example, the contribution component equals a scale factor times a ratio of the dominant contribution value to the importance value and is capped at about 20 points. The contribution component may be zero when the per-feature contribution map is absent or the importance value is non-positive.

Anomaly scoring unit 388 may then apply a feature-specific damper to the contribution component according to co-movement conditions among features. In one example, the feature-specific damper may halve the contribution component when the dominant feature is a port packet rate metric comprising receive or transmit packet counts and a forwarding table occupancy feature has a contribution at least approximately 70% of the dominant contribution. In another example, the feature-specific damper may halve the contribution component when the dominant feature is a total drops metric and a port packet rate feature has a contribution at least approximately 50% of the dominant contribution. In this example, the port packet rate metric and forwarding table occupancy may be equivalent to the features: eth_ports_rx_pkts, eth_ports_tx_pkts, and fdb_in_use defined in Table I, above.

Anomaly scoring unit 388 may sum the base component and the (optionally damped) contribution component, and clamp the sum to a bounded interval to obtain a final importance score. Anomaly scoring unit 388 may use the final importance score for gating which anomalies to report to the customer organization in the form of customer-visible suggestions. Anomaly scoring unit 388 may determine that the anomaly is an important anomaly when the final importance score is equal to or exceeds a gating threshold greater than about 60 for a bounded importance score interval of [0, 100]. At least one of the fixed value, the predetermined high value, the first maximum, the second maximum, the damping factors, and the percentage thresholds are configurable.

FIG. 3C is a block diagram of root cause analysis unit 354 of NMS 300 of FIG. 3A. In the illustrated example, root cause analysis unit 354 includes a feature analysis unit 392, a port analysis unit 394, a configuration analysis unit 395, a packet capture analysis unit 396, and a loop analysis unit 397.

Based on detection of an anomaly, e.g., an actionable and/or important anomaly, VNA 350 of NMS 300 performs root cause analysis based on additional information obtained from the edge device based on the type of anomaly detected. Feature analysis unit 392 may determine the type of the detected anomaly based on which feature of the actual usage statistics has a highest difference value from the predicted usage statistics for the time window. The feature having the highest difference value may be determined as the type of the detected anomaly and trigger further analysis of probably root causes of that anomaly type.

As one example, in the case of a packet drop anomaly (e.g., an anomalous number of aggregate packet drops observed at the edge device during the time window), root cause analysis unit 354 may trigger packet capture analysis unit 396 to further analyze a sample of dropped packets for the time window obtained from a packet capture service at the edge device. In some cases, the sample of dropped packets for the time window includes sample dropped packets for each drop reason of a set of drop reasons tracked by the packet capture service at the edge device. Packet capture analysis unit 396 may determine the root cause of the packet drop anomaly based on the drop reason that has a highest number of dropped packets or is most prevalent in the sample of dropped packets.

In other cases, each sample dropped packet in the sample of dropped packets for the time window includes a header indicating a source address and/or a destination address of the sample dropped packet. Packet capture analysis unit 396 may determine the root cause of the packet drop anomaly based on a most common source address and/or a most common destination address included in the headers of the sample dropped packets.

As another example, in the case of a tunnel drop anomaly (e.g., an anomalous number of average tunnel drops observed at the edge device during the time window), root cause analysis unit 354 may trigger configuration analysis unit 395 to determine whether there was a configuration change (e.g., reboot or upgrade of firmware). For example, configuration analysis unit 395 may analyze the tunnels at the edge device before and after the time of the anomaly to determine whether a drop in the number of tunnels at the edge device correlates to a drop in active APs at a particular site based on site identifiers associated with the active APs, which may be indicative of a site-level configuration change to the APs, or correlates to a drop in active APs across all sites, which may be indicative of an organization-level configuration change to the edge device. Configuration analysis unit 395 may identify the configuration change based on an ID number and/or timestamp included in statistics reported by the edge device and determine that the root cause of the tunnel drop anomaly is a configuration change that precedes the time of the anomaly.

As a further example, in the case of a traffic error anomaly (e.g., an anomalous number of aggregate traffic errors observed at the edge device during the time window), root cause analysis unit 354 may trigger port analysis unit 394 to analyze all input ports on the edge device during the time window. Port analysis unit 394 may identify which switches were connected to which input ports of the edge device and the associated number of aggregate traffic errors observed at each of the input ports of the edge device. In some examples, port analysis unit 394 may analyze drop tables of the tunnel service at the edge device at the time of the anomaly to determine whether traffic drops were due to misconfigured ports/VLANs or filtering of high levels of bad traffic. Port analysis unit 394 may identify which input port of the edge device experienced the highest number of traffic errors during the time window and determine that the root cause of the traffic error anomaly is a physical issue at that input port.

As an additional example, in the case of a high traffic anomaly or high duplicate packet anomaly (e.g., a spike or other anomalous amount of aggregate traffic observed at the edge device during the time window), root cause analysis unit 354 may trigger loop analysis unit 397 to analyze input ports of the edge device to detect loops in the NAS devices, e.g., switches, connected to the input ports. For example, loop analysis unit 397 may determine whether the increase in traffic (and particularly duplicate traffic) is due to a loop in a connected switch. Loop analysis unit 397 may analyze all input ports on the edge device during the time window to identify which switches were connected to which input ports and identify addresses of source ports of the connected switches from link layer discovery protocol (LLDP) messages included in the network data 316 obtained from the edge device. Loop analysis unit 397 may determine that the root cause of the high traffic anomaly is an identified loop associated with a switch or other NAS device connected to the edge device.

Returning to FIG. 3A, based on the determined root cause, VNA/AI engine 350 of NMS 300 may automatically invoke one or more corrective actions intended to address the detected anomaly and the determined root cause. In addition, or alternatively, VNA/AI engine 350 may proactively provide a notification including recommended corrective actions to be taken by IT personnel, e.g., a site or network administrator using an admin device, to address the detected anomaly and the determined root cause.

An example of tunnel size anomaly detection is described herein. The “tunnels_size” feature monitored at a network edge device reflects the number of L2TP tunnels—and hence AP connectivity—to the edge device. Because tunnels_size is mostly constant with occasional level shifts (APs join/leave in batches), anomaly detection unit 352 may employ specialized univariate detectors to capture these changes accurately:

| 1. | Exponentially Weighted Moving Average (EWMA) | |
|---|---|---|
| ∘ | Objective: Create an adaptive baseline m_t and variance σ_t\hat{ }2 that smoothly | |
| | track the historical mean and variability of x_t = tunnels_size. | |
| ∘ | Equations: | |
| | m_t = α · x_t + (1 − α) · m_{t−1} | |
| | v_t = α · (x_t − m_t)\hat{ }2 + (1 − α) · v_{t−1} | |
| | σ_t = √v_t | |
| ∘ | Thresholds: | |
| | Upper_t = m_{t−1} + L · σ_{t−1} | |
| | Lower_t = m_{t−1} − L · σ_{t−1} | |
| ∘ | Detection Rule: | |
| | if x_t > Upper_t → positive anomaly | |
| | if x_t < Lower_t → negative anomaly | |
| ∘ | Parameters: | |
| | α (smoothing factor): e.g., 0.2 (gives ~20% weight to current value). | |
| | L (control limit): e.g., 3 (three-sigma rule). | |
| ∘ | Initialization: | |
| | m_0 = x_series[0] | |
| | v_0 = small positive constant | |
| ∘ | Python Snippet: | |
| | alpha, L = 0.2, 3.0 | |
| | m, v = x_series[0], 1e−3 | |
| | anomalies_ewma = [ ] | |
| | for x_t in x_series[1:]: | |
| | | m = alpha * x_t + (1 − alpha) * m |
| | | v = alpha * (x_t − m)**2 + (1 − alpha) * v |
| | | sigma = math.sqrt(v) |
| | | upper = m + L * sigma |
| | | lower = m − L * sigma |
| | | anomalies_ewma.append(x_t > upper or x_t < lower) |
| ∘ | Rationale: | |
| | ◯ | Adaptivity: Adjusts to gradual trends (e.g., AP rollouts) while remaining |
| | | sensitive to abrupt shifts. |
| | ◯ | Robustness: Uses variance and control limits to minimize false |
| | | positives from random noise. |
| 2. | Cumulative Sum (CUSUM) on Percent Change | |
| ∘ | Objective: Detect sustained shifts in the percent change of tunnels_size, | |
| | filtering out minor fluctuations. | |
| ∘ | Equations: | |
| | Δ_t = (x_t − x_{t−1}) / x_{t−1} | |
| | S_pos[t] = max(0, S_pos[t−1] + Δ_t − drift) | |
| | S_neg[t] = min(0, S_neg[t−1] + Δ_t + drift) | |
| ∘ | Detection Rule: | |
| | if S_pos[t] > h: positive anomaly (reset S_pos[t]=0) | |
| | if abs(S_neg[t]) > h: negative anomaly (reset S_neg[t]=0) | |
| ∘ | Parameters: | |
| | drift: small allowance (e.g., 0.01) to ignore noise. | |
| | h: threshold (e.g., 0.3) for ~30% sustained change. | |
| ∘ | Python Snippet: | |
| | drift, h = 0.01, 0.3 | |
| | S_pos, S_neg = 0.0, 0.0 | |
| | anomalies_cusum = [ ] | |
| | for x_prev, x_t in zip(x_series[:−1], x_series[1:]): | |
| | | delta = (x_t − x_prev) / x_prev if x_prev else 0 |
| | | S_pos = max(0, S_pos + delta − drift) |
| | | S_neg = min(0, S_neg + delta + drift) |
| | | if S_pos > h: |
| | | anomalies_cusum.append(True) |
| | | S_pos = 0 |
| | | elif abs(S_neg) > h: |
| | | anomalies_cusum.append(True) |
| | | S_neg = 0 |
| | | else: |
| | | anomalies_cusum.append(False) |
| ∘ | Rationale: | |
| | ◯ | Sustained Detection: Flags anomalies only when changes accumulate |
| | | beyond noise thresholds. |
| | ◯ | Directional Insights: Separates positive vs. negative shifts, aiding in |
| | | distinguishing AP join vs. leave events. |

| | |
|---|---|
| 3. | Combined Strategy |
| ∘ | EWMA offers continuous, soft-threshold anomaly flags. |
| ∘ | CUSUM captures high-confidence, directional shift events. |
| ∘ | Integration: |
| | z_tun[j] = 1 if anomalies_ewma[j] or anomalies_cusum[j] else 0 |
| | This unified binary indicator Z_tun is then combined with traffic severity scores |

for final anomaly decisions.

Anomaly detection unit 352 may provide a combined serving pipeline and integration as described herein.
1. Input Assembly: Last 72 feature+meta sequences+current tunnels_size.
2. Model Inference: Predict 6 horizons->extract first-horizon predictions.
3. Compute Traffic z-scores+severity_model per timestamp.
4. Compute tunnels z-score (or EWMA flag)→z_tun
5. Composite Severity: severity_final=severity_model+w_tun*z_tun
6. Threshold & Alert: Compare severity_final to 99th pct cutoff; emit anomaly events.

Integration into Spark UDFs for real-time scoring and Kafka event publication.

Monitoring, validation, and next steps are described herein. To ensure the anomaly detection system remains reliable and actionable in production, VNA/AI engine 350 implements a robust monitoring and validation framework, followed by a clear roadmap:

### 1. Back Testing & Performance Evaluation

Historical Incident Replay: Run the model on past windows containing known network incidents to compute:
   ROC/AUC: Measures tradeoff between true and false positive rates.
   Precision/Recall: Ensures high anomaly detection accuracy without excessive false alarms.
   Detection Delay: Time between anomaly onset and model alert.
A/B Testing: Deploy the new model alongside the existing rule based or baseline system to compare alert counts, false positives, and resolution times in live traffic.

### 2. Dashboard & Visualization

Per Edge Time Series: Plot severity scores over time, highlighting peaks above threshold.
Feature Contribution Heatmap: Display top 3 features driving each anomaly with SHAP values.
Alert Metrics: Track daily/weekly alert volume, grouped by site or feature category.
Interactive Drill Down: Enable network operators to click an alert and view underlying raw signals, loss curves, and threshold violations. (Marvis Actions)

### 3. Continuous Validation & Drift Detection

Statistical Drift Tests: Monthly computation of Population Stability Index (PSI) and Kolmogorov-Smirnov (KS) statistics for each feature's distribution versus baseline.
Trigger Retraining: If PSI>0.1 or KS p value<0.05, flag for model retraining or scaling parameter re estimation.
Data Health Monitoring: Watch for gaps, spikes in missing values, and changes in input feature cardinality.

### 4. Adaptive Threshold Management

Rolling Threshold Recalibration: Recompute global/local percentiles and IQRs using a sliding window (e.g., last 90 days) to adapt to evolving traffic patterns.
Threshold Versioning: Tag threshold sets with timestamps, allowing rollback if sudden distribution shifts cause instability.

### 5. Alert Lifecycle & Operations

Debouncing & Grouping: Suppress duplicate alerts for the same edge within a configurable window; group by site to provide summary alerts.
Severity Tiers: Classify alerts into Warning/Critical based on z score ranges to prioritize operator response.
Integration: Publish alerts in ES and links to dashboard details.

### 6. Enhancements

Contextual Signals Integration: Incorporate maintenance schedules, software upgrade windows, and calendar events to reduce false positives.
Graph Based Anomaly Detection: Leverage topology graphs to detect correlated anomalies across multiple edges or sites.
Online Learning: Investigate continual learning methods to adapt to new edges with minimal data.
Explainability & Root Cause Automation: Enhance SHAP driven explanations and automate remediation playbooks based on anomaly type.

This comprehensive monitoring and validation strategy ensures high model reliability, operational efficiency, and continuous improvement for anomaly detection at the network edge.

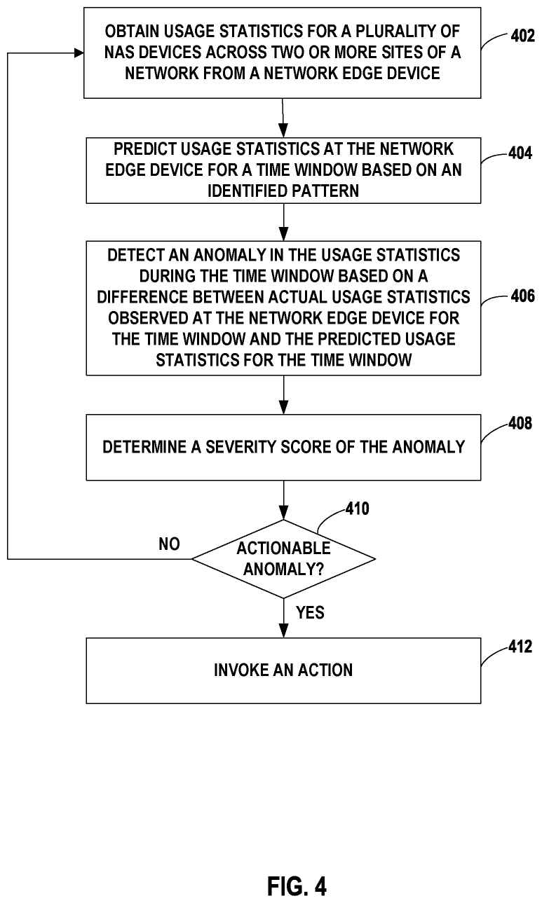

FIG. 4 is a flow chart illustrating an example operation of traffic anomaly detection at a network edge, in accordance with one or more techniques of this disclosure. The example operation of FIG. 4 may be performed by NMS 130 of FIGS. 1A, 1B. In other examples, the operation of FIG. 4 may be performed by NMS 300 of FIGS. 3A-3C.

An NMS obtains usage statistics for a plurality of NAS devices across two or more sites of a network, e.g., an enterprise network, from a network edge device (402). The network edge device provides a centralized data plane for the plurality of NAS devices with access to a cloud-based control plane provided by the NMS. The usage statistics comprise at least one of aggregate usage statistics, average usage statistics for the plurality of NAS devices, or a combination thereof. For example, the usage statistics may be obtained from network data and include aggregate traffic statistics for the plurality of NAS devices and an average number of tunnels established between the plurality NAS devices and a tunnel terminator at the network edge device.

In some examples, the NMS may determine whether to initiate anomaly detection for a particular network edge device based on the usage statistics obtained from the particular network edge device. The NMS may determine whether at least one of a number of clients connected to the plurality of NAS devices, a number of tunnels established between the plurality NAS devices and the network edge device, or a combination thereof satisfies at least one threshold, and based on satisfaction of the at least one threshold, initiate anomaly detection in the usage statistics using a machine learning model trained for the particular network edge device.

The NMS predicts usage statistics at the network edge device for a time window in accordance with a pattern or seasonality identified in the usage statistics (404). The NMS predicts the usage statistics for the time window by first generating features of current network data for the plurality of NAS devices observed at the network edge device for one or more time windows occurring prior to the time window. The NMS applies the features of the current network data for the plurality of NAS devices as input to a machine learning model trained based on the features of historical network data for the plurality of NAS devices observed at the network edge device. The NMS may also apply the pattern identified in the usage statistics as a meta feature to the machine learning model, where the pattern is indicative of seasonality based on at least one of time or a number of clients connected to the plurality of NAS devices.

The NMS 130 detects an anomaly in the usage statistics for the time window based on a difference between actual usage statistics observed at the network edge device for the time window and the predicted usage statistics for the time window (406). For example, the NMS may determine a deviation from one of a minimum value or a maximum value of the predicted usage statistics for the time window. The NMS may determine a severity score of the anomaly (408) and determine whether the severity score of the anomaly is indicative of an actionable anomaly (410). For example, the NMS may determine an actionable anomaly in response to the severity score of the detected anomaly being equal to or greater than 60%. Based on the severity score of the anomaly not being indicative of an actionable anomaly (NO branch of 410), the NMS may not act upon the detected anomaly and continue to obtain and analyze usage statistics from the edge device (402, 404, 406, 408).

Based on the severity score of the anomaly being indicative of an actionable anomaly (YES branch of 410), the NMS invokes an action to correct or remediate the anomaly (412). In some examples, the action may include the NMS determining an importance score of the actionable anomaly and, based on the importance score, determining to report the actionable anomaly to a customer organization. For example, the NMS may determine that the anomaly is an important anomaly based on the importance score satisfying a gating threshold, e.g., approximately equal to or greater than 60 for a bounded importance score interval of [0, 100]. The NMS may then output a notification to report the anomaly to an administrator of the customer organization.

In other examples, the action may include the NMS determining a root cause of the detected anomaly based on a type of the detected anomaly. The NMS may determine the type of the detected anomaly based on which feature of the actual usage statistics has a highest difference value from the predicted usage statistics for the time window. In a case where the anomaly in the usage statistics comprises an anomaly in average tunnel drops observed at the network edge device, the NMS may identify configuration changes to the network edge device or the plurality of NAS devices during the time window.

In one case where the anomaly in the usage statistics comprises an anomaly in aggregate packet drops observed at the network edge device, the NMS may obtain from a packet capture service at the network edge device a sample of dropped packets for the time window for each drop reason of a set of drop reason. The NMS may then determine the root cause of the detected anomaly based on a drop reason of the set of drop reasons that has a highest number of dropped packets in the sample of dropped packets. In another case where the anomaly in the usage statistics comprises an anomaly in aggregate packet drops observed at the network edge device, the NMS may obtain, from the packet capture service at the network edge device, a sample of dropped packets for the time window, and determine the root cause of the detected anomaly based on a most common source or destination address included in headers of the dropped packets in the sample of dropped packets.

In a case where the anomaly in the usage statistics comprises an anomaly in aggregate traffic errors observed at the network edge device, the NMS may analyze input ports of the network edge device to identify which input port experienced the highest number of traffic errors during the time window. In a case where the anomaly in the usage statistics comprises an anomaly in aggregate high traffic observed at the network edge device, the NMS may analyze input ports of the network edge device to detect loops in the NAS devices, e.g., switches, connected to the input ports.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processing resources, rather than sequentially. Further, certain operations, acts, steps, or events may be performed automatically, even if not specifically identified as being performed automatically. Also, certain operations, acts, steps, or events described as being performed automatically may be alternatively not performed automatically, but rather, such operations, acts, steps, or events may be, in some examples, performed in response to input or another event.

Although various Figures are referenced herein in connection with the description of one or more specific examples, such examples are merely illustrative, and each Figure can be used to provide support for other examples not specifically described herein. Accordingly, the one or more examples described herein with reference to a specific Figure should not be construed to narrow the scope or spirit of the subject matter illustrated in that Figure or any other illustration.

In the preceding description, references may be occasionally made to “some examples.” In this disclosure, a reference to “some examples” is intended to mean a subset of all of the possible examples supported by this disclosure. Also, different references to “some examples” are not always a reference to the same subset of examples.

For ease of illustration, only a limited number of systems are shown within the illustrations referenced herein. However, techniques in accordance with one or more aspects of the present disclosure may be performed with many more of such systems, components, devices, applications, units, and/or other items, and collective references to such systems, components, devices, applications, units, and/or other items may represent any number of such systems, components, devices, applications, units, and/or other items.

The illustrations included herein depict at least one example implementation of an aspect of this disclosure. The scope of this disclosure is not, however, limited to such implementations. Accordingly, other examples or alternative implementations of systems, methods or techniques described herein, beyond those illustrated, may be used in other instances. Such implementations may include a subset of the devices and/or components included in the illustrations, and/or may include additional devices and/or components not specifically illustrated.

The description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, known structures and components are shown in block diagram form in the referenced illustrations in order to avoid obscuring such concepts.

Accordingly, although one or more implementations of various systems, devices, and/or components may be described with reference to specific illustrations, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated herein may alternatively be implemented as part of another device or component not shown in such illustrations. In this and other ways, some of the functions described herein may be performed via distributed processing by two or more devices or components.

Further, certain operations, techniques, features, and/or functions may be described herein as being performed by specific components, devices, applications and/or units. In other examples, such operations, techniques, features, and/or functions may be performed by different components, devices, applications, or units. Accordingly, some operations, techniques, features, and/or functions that may be described herein as being attributed to one or more components, devices, applications and/or units may, in other examples, be attributed to other components, devices, applications and/or units, even if not specifically described herein in such a manner. Any references herein to “real time” or equivalent phrases are intended to encompass near-real time or seemingly near-real time, such as from the perspective of a reasonable human observer.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media; or communication media including any medium that facilitates transfer of a computer program from one place to another (e.g., pursuant to a communication protocol). In this manner, computer-readable media generally may correspond to (1) tangible computer-readable storage media, which is non-transitory computer-readable storage media or (2) a communication medium such as a signal or carrier wave. Data storage media may be any available media that can be accessed by one or more computers or one or more processing resources to retrieve instructions, code and/or data structures for implementation of the techniques described in this disclosure. A computer program product may include a computer-readable medium.

By way of example, and not limitation, such computer-readable storage media can include random-access memory (RAM), read-only memory (ROM), non-volatile random-access memory (NVRAM), electrically erasable programmable read-only memory (EEPROM), Flash memory, optical data storage media, magnetic disk storage, or other magnetic storage devices, Solid-State Drive (SSD) storage, or any other medium that can be used to store desired program code in the form of instructions or data structures and that can be accessed by a computer. Also, any connection may properly be referred to as a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium.

Instructions may be executed by one or more processing resources, such as one or more Central Processing Units (CPUs), Graphics Processing Units (GPUs), Digital Signal Processors (DSPs), microprocessors, controllers, Application-Specific Integrated Circuits (ASICs), Field-Programmable Gate Arrays (FPGAs), quantum processors, or other equivalent integrated or discrete logic circuitry. One or more processing resources may be, may be part of, and/or may include processing circuitry that performs operations in accordance with one or more aspects of the present disclosure. The terms “processing resource,” “processor,” or “processing circuitry” as used herein may each refer to any of the foregoing structure or any other structure suitable for implementation of the techniques described. In addition, in some examples, the functionality described may be provided within dedicated hardware and/or software applications and/or units. One or more processing resources of a computing system may implement functionality and/or execute instructions associated with the computing system or associated with one or more applications and/or units illustrated herein and/or described herein. Also, the techniques could be fully implemented in one or more circuits or logic elements.

Where a phrase similar to “at least one of A, B, and C” is used in the claims, it is intended that the phrase be interpreted to mean that A alone may be present; B alone may be present; C alone may be present; or that any combination of the elements A, B, and C may be present, for example, A and B, A and C, B and C, or A and B and C.

Where a phrase similar to “one or more processing resources configured to X, Y, and Z” is used in the claims, it is intended that the phrase be interpreted to mean at least: that a first processing resource alone may perform functions X, Y, and Z; that two or more processing resources (e.g., processors A and B) may collectively perform functions X, Y, and Z; that a first processing resource may perform functions X and Y and a second processing resource may perform function Z; or that a first processing resource may perform function X, a second processing resource may perform function Y, and a third processing resource may perform function Z. Furthermore, the phrase “instructions executable by the one or more processing resources to cause the computing system to” or similar phrase is intended to encompass functions performed by the computing system and resulting from the execution of the instructions by any combination of the one or more the processing resources.

The techniques of this disclosure may be implemented in a wide variety of devices or apparatuses, including, to the extent appropriate, a mobile or non-mobile computing device, a wearable or non-wearable computing device, an integrated circuit (IC) or a set of ICs (e.g., a chip set). Various components, applications, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processing resources as described above, in conjunction with suitable software and/or firmware.

What is claimed is:

1. A network management system (NMS) comprising:
one or more processing resources; and
one or more non-transitory computer-readable storage media comprising instructions executable by the one or more processing resources to cause the NMS to:
obtain usage statistics for a plurality of network access server (NAS) devices across two or more sites of a network from a network edge device, wherein the network edge device provides a centralized data plane for the plurality of NAS devices with access to a cloud-based control plane provided by the NMS, and wherein the usage statistics comprise at least one of aggregate usage statistics, average usage statistics, or a combination thereof for the plurality of NAS devices;
predict usage statistics at the network edge device for a time window in accordance with a pattern identified in the usage statistics;
detect an anomaly in the usage statistics for the time window based on a difference between actual usage statistics observed at the network edge device for the time window and the predicted usage statistics for the time window; and
determine a root cause of the detected anomaly based on a type of the detected anomaly.

2. The NMS of claim 1, wherein the usage statistics comprise aggregate traffic statistics for the plurality of NAS devices and an average number of tunnels established between the plurality of NAS devices and a tunnel terminator at the network edge device.

3. The NMS of claim 1, wherein the instructions cause the NMS to:
determine whether at least one of a number of clients connected to the plurality of NAS devices, a number of tunnels established between the plurality of NAS devices and the network edge device, or a combination thereof satisfies at least one threshold; and
based on satisfaction of the at least one threshold, initiating anomaly detection in the usage statistics using a machine learning model trained for the network edge device.

4. The NMS of claim 1, wherein to obtain the usage statistics for the plurality of NAS devices, the instructions cause the NMS to generate features of current network data for the plurality of NAS devices observed at the network edge device for one or more time windows occurring prior to the time window.

5. The NMS of claim 4, wherein to predict the usage statistics for the time window, the instructions cause the NMS to apply the features of the current network data for the plurality of NAS devices as input to a machine learning model trained based on the features of historical network data for the plurality of NAS devices observed at the network edge device.

6. The NMS of claim 5, wherein to predict the usage statistics for the time window, the instructions cause the NMS to apply the pattern identified in the usage statistics as a meta feature to the machine learning model, wherein the pattern is indicative of seasonality based on at least one of time, a number of clients connected to the plurality of NAS devices, or a combination thereof.

7. The NMS of claim 1, wherein to detect the anomaly in the usage statistics for the time window, the instructions cause the NMS to determine a deviation from one of a minimum value or a maximum value of the predicted usage statistics for the time window.

8. The NMS of claim 1, wherein to detect the anomaly in the usage statistics, the instructions cause the NMS to:
determine a severity score of the anomaly; and
determine that the severity score of the anomaly is indicative of an actionable anomaly.

9. The NMS of claim 1, wherein to detect the anomaly in the usage statistics, the instructions cause the NMS to:
determine an importance score of the anomaly; and
based on the importance score, outputting a notification to report the anomaly to a customer organization of the network.

10. The NMS of claim 1, wherein to determine the root cause of the detected anomaly, the instructions cause the NMS to determine the type of the detected anomaly based on which feature of the actual usage statistics has a highest difference value from the predicted usage statistics for the time window.

11. The NMS of claim 1, wherein the anomaly in the usage statistics comprises an anomaly in average tunnel drops observed at the network edge device, and wherein to determine the root cause, the instructions cause the NMS to identify configuration changes to the network edge device or the plurality of NAS devices during the time window.

12. The NMS of claim 1, wherein the anomaly in the usage statistics comprises an anomaly in aggregate packet drops observed at the network edge device, and wherein to determine the root cause, the instructions cause the NMS to:
obtain, from a packet capture service at the network edge device, a sample of dropped packets for the time window for each drop reason of a set of drop reasons; and
determine the root cause of the detected anomaly based on a drop reason of the set of drop reasons that has a highest number of dropped packets in the sample of dropped packets.

13. The NMS of claim 1, wherein the anomaly in the usage statistics comprises an anomaly in aggregate packet drops observed at the network edge device, and wherein to determine the root cause, the instructions cause the NMS to:
obtain, from a packet capture service at the network edge device, a sample of dropped packets for the time window; and
determine the root cause of the detected anomaly based on a most common source address or a most common destination address included in headers of the dropped packets in the sample of dropped packets.

14. The NMS of claim 1, wherein the anomaly in the usage statistics comprises an anomaly in aggregate traffic errors observed at the network edge device, and wherein to determine the root cause, the instructions cause the NMS to analyze input ports of the network edge device to identify which input port experienced a highest number of traffic errors during the time window.

15. The NMS of claim 1, wherein the anomaly in the usage statistics comprises an anomaly in aggregate high traffic observed at the network edge device, and wherein to determine the root cause, the instructions cause the NMS to analyze input ports of the network edge device to detect loops in the NAS devices connected to the input ports.

16. The NMS of claim 1, wherein the network edge device is located on-premises at one of the two or more sites of the network or at a data center of the network.

17. A method comprising:
obtaining, by a network management system (NMS), usage statistics for a plurality of network access server (NAS) devices across two or more sites of a network from a network edge device, wherein the network edge device provides a centralized data plane for the plurality of NAS devices with access to a cloud-based control plane provided by the NMS, and wherein the usage statistics comprise at least one of aggregate usage statistics, average usage statistics, or a combination thereof for the plurality of NAS devices;
predicting, by the NMS, usage statistics at the network edge device for a time window in accordance with a pattern identified in the usage statistics;
detecting, by the NMS, an anomaly in the usage statistics for the time window based on a difference between actual usage statistics observed at the network edge device for the time window and the predicted usage statistics for the time window;
determining, by the NMS, a severity score of the anomaly; and
based on the severity score of the anomaly being indicative of an actionable anomaly, invoking, by the NMS, an action.

18. The method of claim 17, wherein invoking the action comprises determining a root cause of the anomaly based on a type of the anomaly.

19. The method of claim 17, wherein invoking the action comprises:
determining an importance score of the anomaly; and
based on the importance score, outputting a notification to report the anomaly to a customer organization of the network.

20. One or more non-transitory computer-readable storage media comprising instructions executable by one or more processing resources to cause a system to:
obtain usage statistics for a plurality of network access server (NAS) devices across two or more sites of a network from a network edge device, wherein the network edge device provides a centralized data plane for the plurality of NAS devices with access to a cloud-based control plane, and wherein the usage statistics comprise at least one of aggregate usage statistics, average usage statistics, or a combination thereof for the plurality of NAS devices;
predict usage statistics at the network edge device for a time window in accordance with a pattern identified in the usage statistics;
detect an anomaly in the usage statistics for the time window based on a difference between actual usage statistics observed at the network edge device for the time window and the predicted usage statistics for the time window; and
determine a root cause of the detected anomaly based on which feature of the actual usage statistics has a highest difference value from the predicted usage statistics for the time window.
